(19) United States
(12) Patent Application Publication
(10) Pub. No.: US 2002/0091599 A1
(43) Pub. Date: Jul. 11, 2002

(54) Terminal device and accounting system for communication service

(76) Inventors: Hiroyo Masuda, Kawasaki (JP); Masaya Suzuki, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/904,686

(22) Filed: Jul. 13, 2001

(30) Foreign Application Priority Data
Jan. 10, 2001 (JP) 2001-003049

(51) Int. Cl. G06F 17/60

(52) U.S. Cl. 705/30

(57) ABSTRACT

A terminal device of the present invention is connected via a communication line to a network for providing a subscriber with a communication service to which a plurality of accounting methods can be applied, and operated by the subscriber when utilizing the communication service. The terminal device displays an accounting quantity corresponding to each of a plurality of accounting methods in the process of utilizing the communication service.

### BACKGROUND OF THE INVENTION

1. Field of the Invention

The present invention relates to a terminal device used when utilizing a communication service, and to an accounting system for the communication service.

2. Description of the Related Art

A variety of communication services such as transmitting and receiving the data via a network have been provided by operating an information processing terminal like a mobile telephone terminal, a personal computer (PC) and so on. For instance, specific mobile telephone terminals (i-mode etc) are capable of utilizing communication services such as voice communications, E-mails, World Wide Web (WWW) and so forth. The communication services are charged fees based on a variety of accounting modes. For example, the voice communication is charged a fee based on time-basis accounting in which the fee is calculated based on a unit communication time. The services for delivering the E-mail and utilizing WWW are charged based on rate accounting of packets in which the fee is calculated based on a unit packet quantity or a unit packet count. Further, some of the communication services have a local discount (for communications to specified areas) or a time-zone discount (for communications in a specific time zone).

Communication services categorized as packet communications and voice communications as on VOIP (Voice over IP) have come out over the recent years. Both of the time-basis accounting and the packet rate accounting can be applied to this type of communications.

At the present, a pre-registration method is adopted. The pre-registration method is that a user (subscriber) of the communication service, when establishing a contract for utilizing the communication service, selects and registers one accounting mode. Therefore, the subscriber is allowed to select only one accounting mode even though a plurality of accounting modes can be applied to the contract target communication service. Further, if the subscriber wants to use other accounting mode, the contract must be re-established based on other accounting mode. Accordingly, for example, the subscriber can not separately use the plurality of accounting modes per communication (call) in a given communication service. Moreover, there is an AOC (Advice of Service) as a technology for the subscriber to comprehend an accounting state of the communication service. According to the AOC, a call fee is displayed, or the user is notified of this call fee during the call or after finishing the call. The AOC is, however, capable of helping the user comprehend the accounting state in one single accounting mode. Namely, according to the AOC, the subscriber is unable to grasp which accounting mode among the plurality of accounting mode applicable to a given communication service is actually applied and what condition this accounting mode is applied under. Hence, it is difficult at the present for the subscriber to select an accounting mode suited to the condition under which the communication service is utilized.

It is predicted that accounting target elements (which may be called accounting elements such as a communication time, a packet quantity, a packet count, details of communication etc) for the communication services, increase so that as the communications media are diversified in the near future. A prediction followed by this trend is that it is more difficult for the subscriber to select a proper accounting mode.

### SUMMARY OF THE INVENTION

It is an object of the present invention to provide a terminal device capable of grasping, when a subscriber utilizes a communication service applicable to a plurality of accounting modes, an accounting system suited to this service utilizing condition.

To accomplish the first object, according to a first aspect of the present invention, a terminal device connected via a communication line to a network for providing a subscriber with a communication service to which a plurality of accounting methods can be applied, and operated by the subscriber when utilizing the communication service, comprises a display unit for displaying an accounting quantity corresponding to each of the plurality of accounting methods in the process of utilizing the communication service.

According to the first aspect of the invention, the accounting quantity is displayed for every accounting method in the process of utilizing the communication service, and hence the subscriber is able to grasp the optimum accounting method with reference to the accounting quantity.

### BRIEF DESCRIPTION OF THE DRAWINGS

FIG. 1 is a diagram showing a accounting system in a first embodiment;

FIG. 2 is a block diagram showing a terminal device;

FIG. 3 is a diagram showing a front of the terminal device shown in FIG. 1, and an accounting mode selection screen;

FIG. 4 is a sequence diagram showing an operational example when displaying an accounting state;

FIG. 5 is an explanatory diagram showing a format of a packet communication request message;

FIG. 6 is a flowchart showing a reply message creation process;

FIG. 7 is an explanatory diagram showing a format of a packet communication “OK” message (reply message);

FIG. 8 is a flowchart showing an accounting state display process;

FIG. 9 is a diagram showing an example of the accounting state display screen;

FIG. 10 is a diagram showing a modified example of the first embodiment;

FIG. 11(A) is a diagram showing an example of the accounting mode selection screen in a second embodiment;

FIG. 11(B) is a diagram showing an example of a registered accounting mode selection screen;

FIG. 11 (C) is a diagram showing an example of an accounting state display screen in the second embodiment;

FIG. 12 is a sequence diagram showing an operational example in the second embodiment;

FIG. 13 is an explanatory diagram showing a packet communication request message in the second embodiment;

FIG. 14 is an explanatory diagram showing the packet communication “OK” message in the second embodiment;

FIG. 15(A) is a diagram showing an example of the accounting mode selection screen in a third embodiment;

FIG. 15(B) is a diagram showing an example of the registered accounting mode selection screen in the third embodiment;

FIG. 16(A) is a sequence diagram showing an operational example in the third embodiment;

FIG. 16(B) is an explanatory diagram showing the packet communication request message in the third embodiment;

FIG. 16(C) is an explanatory diagram showing the packet communication “OK” message in the third embodiment;

FIG. 17 is a diagram showing an example of displaying the screen in a fourth embodiment;

FIG. 18 is an explanatory diagram showing a format of a DISC/REL message;

FIG. 19 is an explanatory diagram showing a format of an accounting method setting message;

FIG. 20 is a diagram showing an display example of an accounting method selection screen;

FIG. 21 is a sequence diagram showing an operational example of the system in a fifth embodiment;

FIG. 22 is an explanatory diagram showing a subscriber database;

FIG. 23 is a sequence diagram showing an operational example of the system in a sixth embodiment;

FIG. 24 is a sequence diagram showing an operational example of the system in a seventh embodiment;

FIG. 25(A) is a diagram showing a display example of a packet forwarding screen 32;

FIG. 25(B) is a diagram showing a display example of an accounting method specifying screen 33;

FIG. 26 is a diagram showing a system architecture in an eighth embodiment;

FIG. 27 is a sequence diagram showing an operational example of the system in the eighth embodiment;

FIG. 28 is a diagram showing an example of a communication record (accounting data) corresponding to a subscriber identifier accumulated in the database;

FIG. 29 is a diagram showing an display example of a result-of-settlement screen;

FIG. 30 is an explanatory diagram showing a packet request message in the eighth embodiment;

FIG. 31 is a sequence diagram showing an operational example of the system in a ninth embodiment;

FIG. 32 is a diagram showing an example of an accounting data display screen;

FIG. 33 is a diagram showing a system architecture in a tenth embodiment;

FIG. 34 is a sequence diagram showing an operational example of the system in the tenth embodiment;

FIG. 35 is a sequence diagram showing an operational example of the system in en eleventh embodiment;

FIG. 36 is a diagram showing a display example of a communication method selection screen;

FIG. 37 is a diagram showing a display example of a service category (call category) selection screen;

FIG. 38 is a diagram showing a display example of a communication quantity input screen;

FIG. 39 is a diagram showing a display example of a parameter determination screen;

FIG. 40 is a diagram showing a display example of an on-communication-process screen; and

FIG. 41 is a diagram showing a display example of a communication continuation selection screen.

### DETAILED DESCRIPTION OF THE PREFERRED EMBODIMENTS

Embodiments of the present invention will hereinafter be described with reference to the accompanying drawings. Each of the following embodiments is exemplification of the present invention, and the present invention is not limited to the embodiments. Further, even if a mobile network is replaced with an existing fixed switch network and an ISP (Internet Service Provider) connection, the present invention can be embodied.

[First Embodiment]

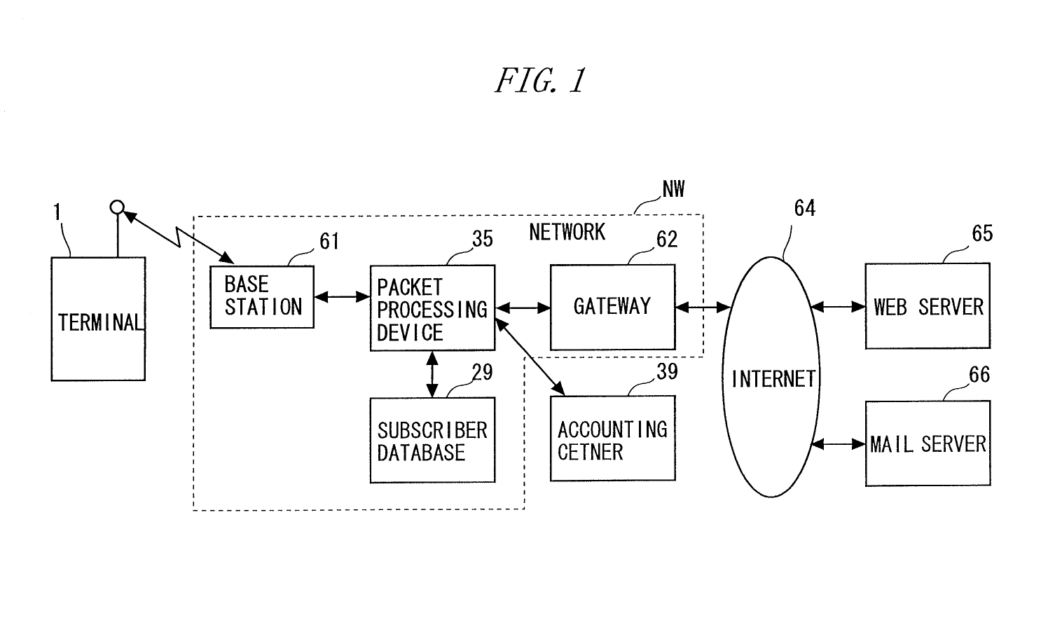

FIG. 1 is a diagram showing an example of a system architecture in a first embodiment. Referring to FIG. 1, the system is configured by a terminal device 1, a network NW, an accounting center 39 connected to the network NW.

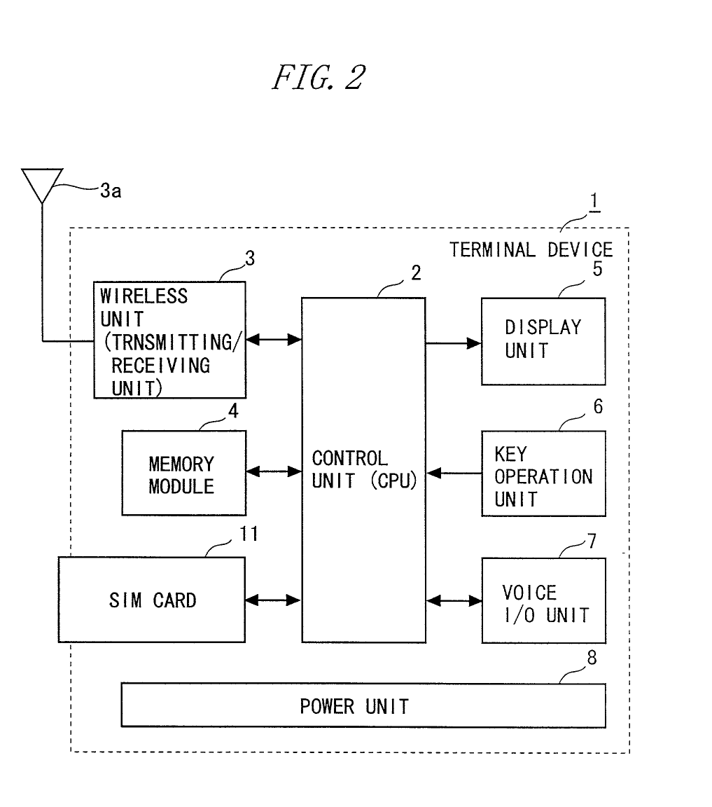

FIG. 2 is a block diagram showing the terminal device 1.

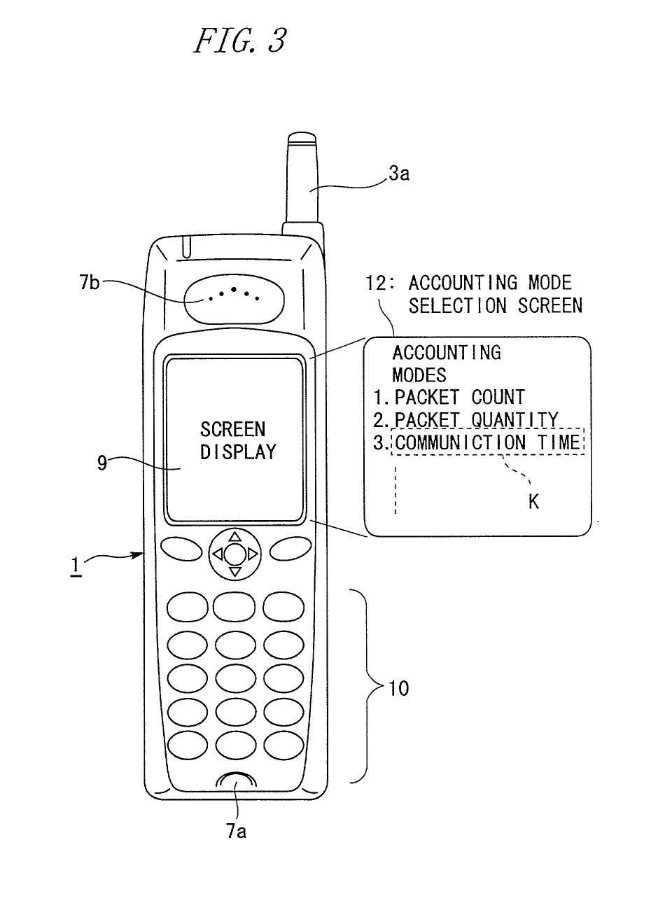

FIG. 3 is a view showing a front configuration of the terminal device 1 and an accounting mode selection screen 12. In the first embodiment, a mobile telephone terminal (I-mode, cdma-One etc) is used as the terminal device 1. A subscriber is able to utilize communication services of a plurality of categories which are provided from the network NW by operating the terminal device 1.

What can be used as the terminal device 1 according to the present invention may be terminal devices such as a PC, a workstation (WS) personal digital assistants (PDA) and a mobile computer, capable of utilizing the communication services, to which fee accounting modes (accounting methods) of a plurality of categories can be applied.

Referring to FIGS. 2 and 3, the terminal device 1 includes a control unit (CPU) 2, a wireless unit 3 connected to the control unit 2, a memory module 4, a display unit 5, a key operation unit 6, a voice input/output unit 8 and a power unit 9.

The wireless unit 3 controls a transmitting/receiving function of radio waves through an antenna 3a, and a radio wave control function (of converting electric signals into radio waves and vice versa). The display unit 5 includes an LCD (Liquid Crystal Display) 9 (FIG. 2) as a display device provided in the terminal device 1, and controls displaying the information on the LCD 9.

The key operation unit 6 includes a plurality of operation keys (buttons) 10 provided on the terminal device 1. When the subscriber operates the operation key 10, the key operation unit 6 analyzes a content of this event and notifies the control unit 2 of a result of this analysis.

The voice I/O unit 7 has a microphone 7a and a loudspeaker 7b, whereby a voice is taken in as electric signals via the microphone 7a and supplied to the control unit 2, and the electric signals received from the control unit 2 are outputted as a voice from the loudspeaker 7b.

The control unit 2 executes programs stored in the memory module 4, thereby actualizing a variety of functions. For instance, the control unit 2 controls an analysis/control function of the signals transmitted to and received from the network NW (FIG. 3). Further, the control unit 2 makes the terminal device 1 function as a telephone terminal. Moreover, the control unit 2 actualizes an input/output function of the information stored in the memory module 4, and an assembly function of a packet massage when forwarding a packet.

The memory module 4 is stored with the programs executed by the control unit 2, the data used for executing the programs, received messages, an address book etc. Further, the memory module 4 is used as an operation area for the control unit 2 or a video memory for retaining information displayed on the LCD 9 by the display unit 5. The power unit 8 supplies the respective units with electric power for operations thereof.

Furthermore, the terminal device 1 includes an unillustrated connector through which an SIM (Subscriber Identity Module) card 11 can be attached. The SIM card 11 is defined as an IC card used in a way that inset this card 11 into the mobile telephone or the PDA, and generally subscriber's information and information on an abbreviated dial etc are written to the card 11.

The SIM card 11, when attached through the connector to the terminal device 1, comes to a state of being electrically connected to the control unit 2. The control unit 2 is capable of writing the information to the SIM card 11 and reading the information stored on the SIM card 11. Namely, the SIM card 11 functions as a recording medium for storing the information used by the control unit 2.

Referring back to FIG. 1, the network NW is defined as a mobile packet communication network, and includes a plurality of base stations 61, packet processing devices 35 connected to the respective base stations 61, subscriber databases 29 connected to the packet processing devices 35, and gateways 62 connected to the packet processing devices 35 and to the subscriber databases 29. The packet processing device 35 may be, for example, a packet switch.

Each base station 61 is provided in each of wireless zones into which the ground is segmented by a predetermined range, and performs wireless communications with the terminal devices 1. The packet processing device 35 accepts a packet communication request given from the terminal device 1 via the base station 61, then executes a call connection process and controls packet switching. The subscriber database 29 retains the information on the subscribers (the users of the terminal devices 1) of the packet communication service.

The gateway 62 controls a protocol conversion for connecting the network NW to the Internet 64. The network NW is connected via the Internet 64 to a Web server 65 and to a mail server 66. The terminal device 1 is thereby capable of ACCESSING THE Web Site provided from the Web server 65 and delivering an E-mail to the mail server 66.

The accounting center 39 receives an accounting ticket from the packet processing device 35 and executes a settlement process (a calculation of a communication service fee) for the communication service on the basis of information contained in the accounting ticket.

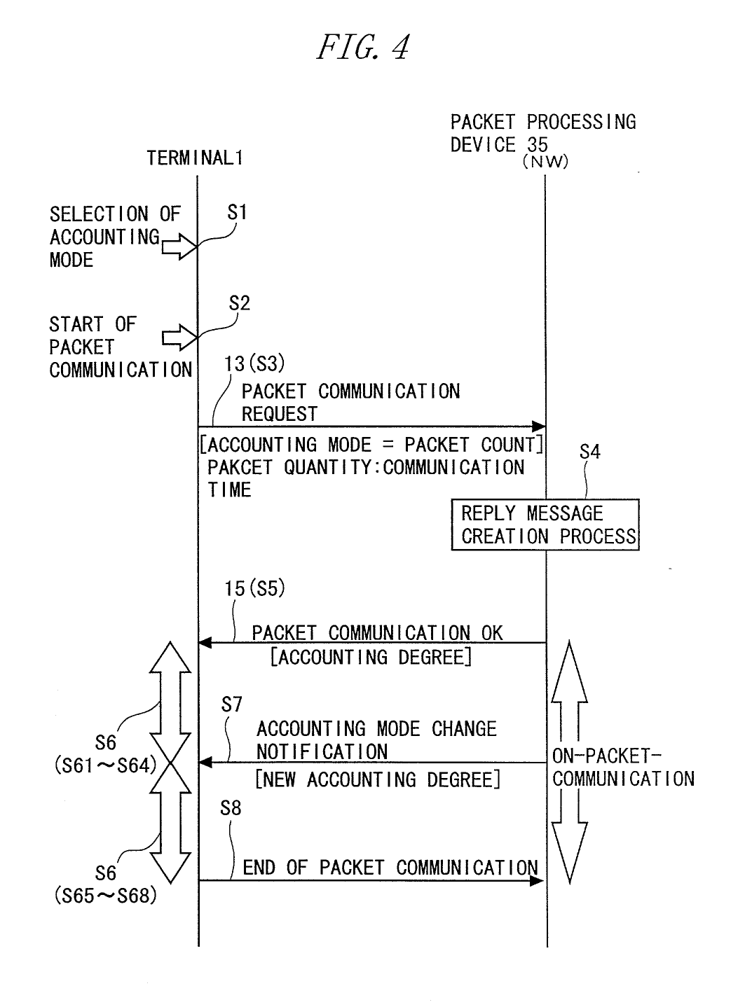

FIG. 4 is a sequence diagram showing an operational example (a method of displaying an accounting mode of the communication service) of the system according to the first embodiment. Note that a premise of the operational example is that the subscriber, on the occasion of making the use of the communication service, previously establishes a contract about the accounting mode with the communication service provider. The accounting mode agreed upon will hereinafter be called a [default accounting mode] as the case may be.

Explained as an operational example is a case where the subscriber delivers the E-mail to the mail server 66 by operating the terminal device 1. Referring to FIG. 3, the user (the subscriber of a cellular service) of the terminal device 1 makes a preparation (inputting of header information and a text) for delivering the E-mail.

Thereafter, the subscriber, before pressing an E-mail delivery button, selects at least one of (accounting elements) the accounting modes, which is desired to be displayed by the subscriber himself or herself, and registers this accounting element on the SIM card 11 (step S1). This registration process is executed as follows. To begin with, the subscriber displays an accounting mode selection screen 12 on the LCD 9 by operating a key 10 on the terminal device 1. To be more specific, when the subscriber operates the key for displaying the accounting mode selection screen 12, the key operation unit 6 notifies the control unit 2 of this event. The control unit 2 issues to the display unit 5 a command of displaying the accounting mode selection screen 12 on the LCD 9. The display unit 5 creates on the memory module 4 pieces of data for displaying the accounting mode selection screen 12, and displays, based on the created data for display, the accounting mode selection screen 12 on the LCD 9. The accounting mode selection screen 12 shown in FIG. 2 is thereby displayed.

Referring again to FIG. 3, a plurality of accounting elements as the accounting modes, which are selectable by the subscriber, are displayed on the accounting mode selection screen 12. In the first embodiment, the accounting elements such as [Rate accounting based on packet account], [Rate accounting based on packet quantity] and [Communication time (Time accounting)] are given as the accounting modes. The accounting elements of [1. Packet count], [2. Packet quantity] and [3. Communication time] are displayed as the accounting modes on the screen 12. Note that a time-basis accounting mode (based on, e.g. , a packet quantity or packet count per unit time) may also be adopted. The subscriber manipulates a cursor K displayed on the screen 12, thus selecting at least one of the accounting elements displayed on the screen 12.

When the accounting element is selected, the control unit 2 stores (registers), on the SIM card 11, a piece of information on the accounting mode corresponding to the accounting element selected. Thus, the registration process of the accounting mode is executed. Incidentally, it is assumed that the subscriber selects [Rate accounting based on packet quantity] as a default accounting mode.

Thereafter, the subscriber operates the operation key 10 and presses the E-mail delivery button. Then, the control unit 2 of the terminal device 1 creates a message 13 of a request for the packet communication (request for starting a session) in order to start the packet communications as the communication service for delivering the E-mail (step S2).

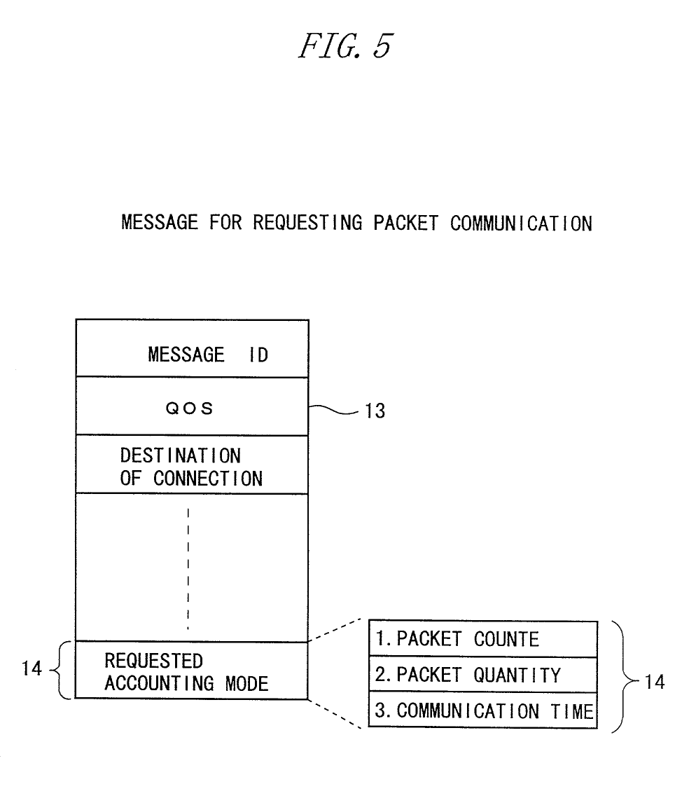

FIG. 5 is an explanatory diagram showing a format of the packet communication request message 13. The message 13 has, in addition to the existing fields for storing a message ID, a QoS (Quality of Service.), a piece of information about a connecting destination etc, a new field 14 for storing a parameter for indicating the accounting mode registered by the subscriber. Namely, the message 13 has the new field 14, i.e. a [Requested accounting mode] field as a parameter area containing parameters.

The control unit 2 sets in the field 14 a parameter indicating the accounting mode registered on the SIM card 11. Herein, for instance, all the accounting elements [1. Packet count], [2. Packet quantity] and [3. Communication time] are selected and registered in the registration process described above, in which case these parameters of the accounting mode are, as shown in FIG. 5, set in the field 14. Thus, when making the request for the start of session, the desired parameters are set in the accounting mode field.

Referring back to FIG. 4, the terminal device 1 delivers the created message 13 to the network NW (step S3). The network NW (e.g., the packet processing device 35 in the network NW), when receiving the message 13, executes a reply message creation process (step S4).

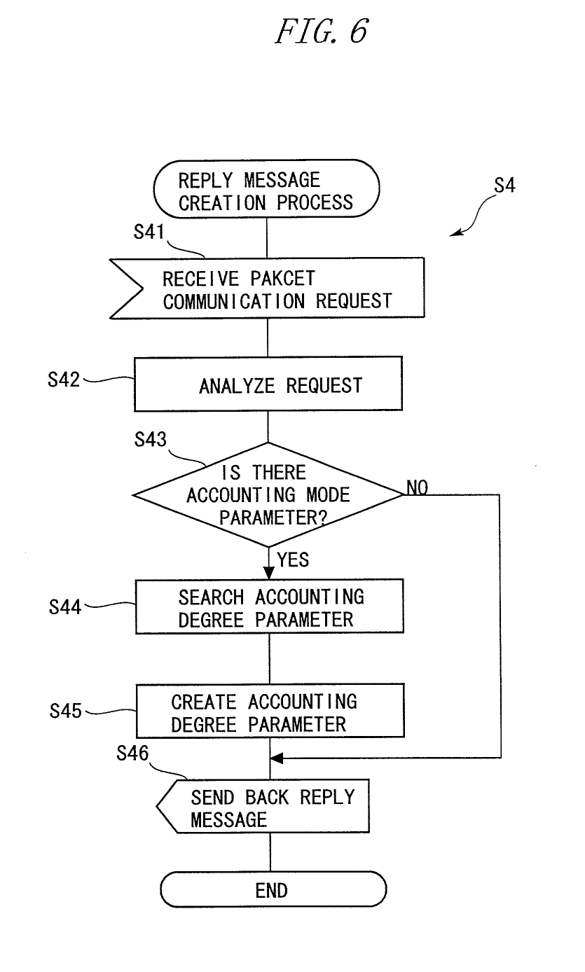

FIG. 6 is a flowchart showing the reply message creation process (S4). The network NW, when receiving the message 13 (step S41), analyzes the request contained in the message 13 (step S42), and the terminal device 1 executes processes (the call connection process etc) necessary for performing the packet communications via the network NW.

At this time, the network NW judges whether or not the field 14 contains the parameters (the data of the accounting mode) of the accounting mode in which the present communication service (the packet communication) is charged a fee (step S43). If contained, pieces of information on accounting degrees corresponding to the accounting mode are searched and obtained from the subscriber database 29 (step S44).

The information on each accounting degree may be defined as information indicating a fee per unit with respect to the accounting element. If the accounting element is [1. Packet count], the information on the accounting degree indicates “a fee per unit number of packets”. Further, if the accounting element is [2. Packet quantity], the information on the accounting degree indicates “a fee per unit number of bytes (bits)”. Moreover, if the accounting element is [3. Communication time], the information on the accounting degree indicates “a fee per unit time”.

Next, the network NW, when obtaining the information on the accounting degree, creates a parameter of the accounting degree by sue of the thus obtained information on the accounting degree (step S45). Next, the network NW creates an “OK” message (a reply message) 15 for the packet communication.

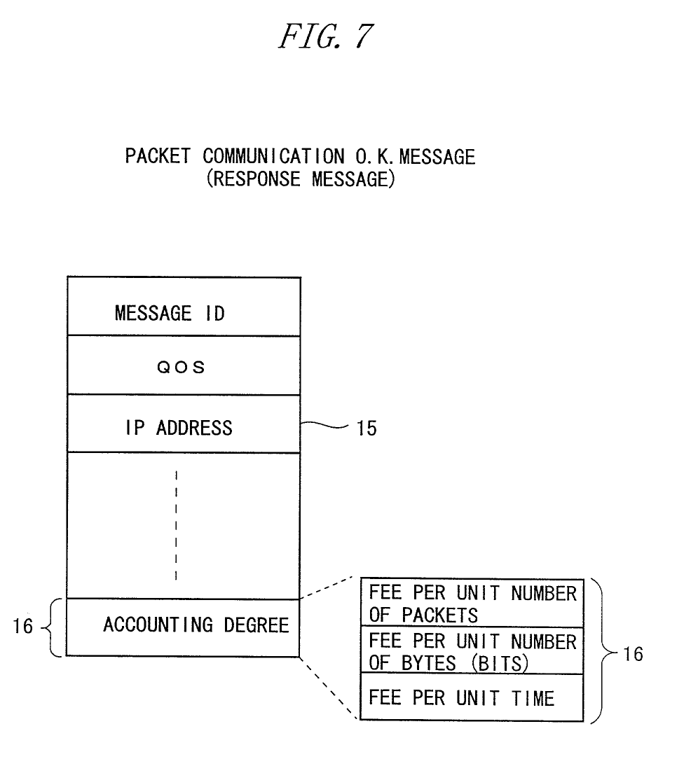

FIG. 7 is an explanatory diagram showing a format of the reply message 15. The message 15 has, in addition to the existing fields for storing a message ID, a QoS, an IP address etc, a new field 16 as a parameter area. The created parameter of the accounting degree is stored in the field 16. Thereafter, the network NW sends the created reply message back to the terminal device 1 (step S46), thus finishing the process of creating the reply message 15.

Referring back to FIG. 4, the reply message 15 is transmitted from the network NW (step S5), and, when the terminal device 1 receives the reply message 15, a call of the packet communication is established, thereby performing the packet communications between the terminal device 1 and the network NW. Namely, the terminal device 1 delivers the E-mail to the mail server 66 via the network NW. During the packet communications, an accounting value display process is executed on the terminal device 1 (step S6). An accounting value of the registered accounting mode is displayed on the LCD 9.

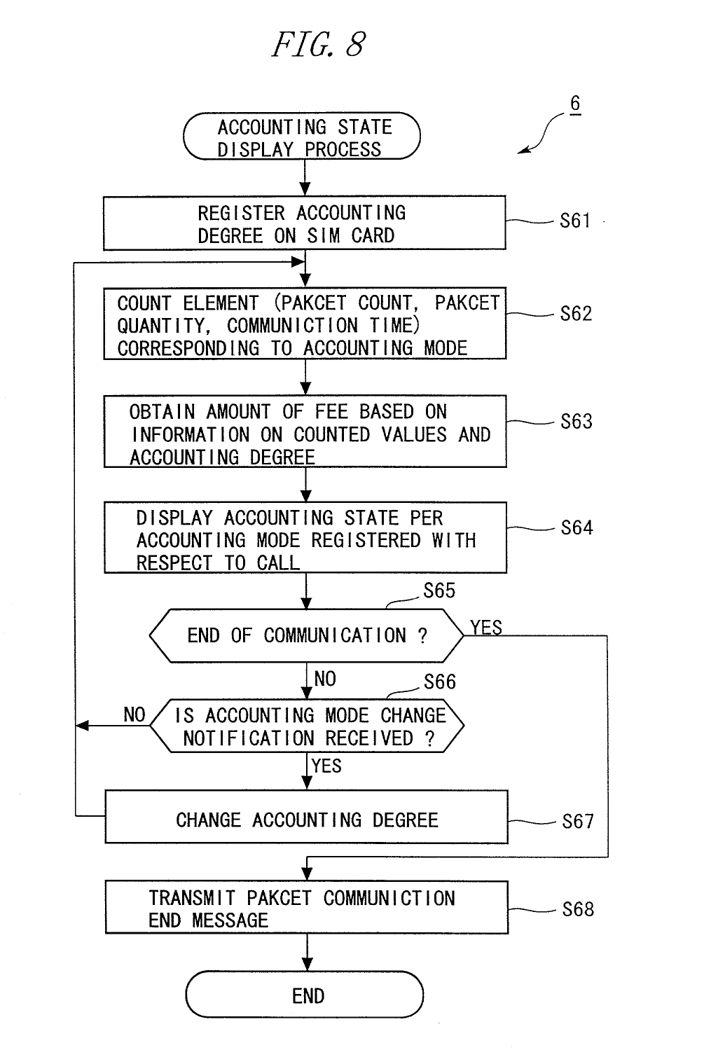

FIG. 8 is a flowchart showing the accounting value display process. Referring to FIG. 8, the control unit 2 of the terminal device 1 at first registers (the parameter of) the accounting degree contained in the reply message 15 on the SIM card 11 (step S61).

Next, the control unit 2 counts the corresponding accounting elements in accordance with the accounting mode registered (step S62). In this example, the packet count, the packet quantity (the number of bytes) and the communication time are counted as the accounting elements for the duration from a start of the packet communication down to an end thereof.

Next, the control unit 2 obtains an accounting quantity per accounting mode by use of a result of counting and an accounting degree (step S63). The accounting quantity may be defined as a fee (an amount of money) for the communication service (which is herein the packet communication) to be charged a fee corresponding to the accounting mode.

Subsequently, the control unit 2 displays the accounting value of each accounting mode on the LCD 9 (step S64). That is, the control unit 2 gives the display unit 5 a command of displaying an accounting value display screen 17. The display unit 5 creates display data of the accounting value display screen 17 on the memory module 4, and displays the accounting value display screen 17 based on the display data created.

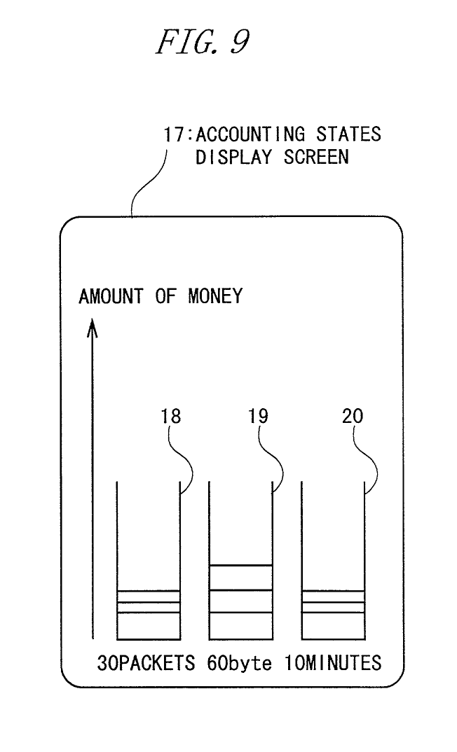

FIG. 9 is a diagram showing a screen display example of the accounting value display screen 17. Indicators 18 20 for indicating an accounting quantity are displayed on the screen 17 in order to display the accounting value of every accounting mode. Values (the packet count, the packet quantity and the communication time) of the accounting elements, which have been counted in step S62, are displayed under the indicators 18 20.

The indicators 18˜20 are displayed in a state of being disposed at the same horizontal level, wherein each height in the vertical direction indicates a magnitude of accounting quantity. Namely, each of the indicators 18˜20 functions as a bar graph indicating the accounting quantity in each of the accounting modes. The accounting value display screen 17 is displayed, whereby the accounting state (the accounting element and the accounting quantity) of the packet communication is displayed per accounting mode.

Note that all the accounting modes are selected and registered in this example, and hence the indicators 18˜20 corresponding to the registered accounting modes are displayed on the screen 17, showing a process of how the accounting quantities rise. By contrast, if any one of the accounting modes is not selected, the indicator corresponding to the unselected accounting mode, though displayed, indicates no increase in the accounting quantity. Instead, the indicator corresponding to the unselected accounting mode may not be displayed. Further, the terminal device 1 is capable of displaying screens other than the accounting value display screen 17 during the on-duty status of the communication service (during the packet communications), and the accounting value display screen 17 may be set to be invoked as the necessity arises. In the example given above, the plurality of accounting values are displayed (simultaneously) on the single screen, however, each of the accounting values may also be displayed by switching the screen.

Referring back to FIG. 8, the terminal device 1 judges whether the packet communication concerned is finished (whether the delivery of the E-mail is finished or not) (step S65). If finished (if the delivery of the E-mail is finished) (step S65;Y) the terminal device 1 sends an end-of-packet-communication message (step S8: FIG. 4) with this processing, the network NW executes a call disconnection process of the packet communication and also a resource restoring process.

Whereas if the packet communication is not finished (if the delivery of the E-mail is not finished) (step S65; N), the terminal device 1 judges whether or not the device 1 itself receives a notification of an accounting change from the network NW (step S66). The network NW, if the accounting degree in the packet communication is changed corresponding to a time and when it comes to the time of changing the accounting degree during the packet communication, creates a message of the accounting change notification containing a parameter (data) of the accounting degree after being changed (step S7).

The terminal device 1, when receiving the accounting change notification and making a YES judgement in step S66, rewrites each accounting degree registered on the SIM card 11 into an accounting degree contained in the accounting change notification (step S67). Thereafter, the processing loops back to step S62. In the display process on the accounting sate display screen 37 in subsequent steps S63 and S64, the accounting quantity corresponding to each accounting mode is obtained by use of the accounting degree changed.

By the way, the terminal device 1, when receiving the accounting change notification, outputs a voice (audible tone) announcing the change in the accounting degree from the loudspeaker of the voice I/O unit 7. The subscriber is thereby able to recognize the change in the accounting degree. Further, the terminal device 1, when notified of the accounting change and changing the accounting degree, display colors of the indicators 18˜20 indicating the accounting quantities are changed. That is, the accounting quantity is displayed in a different color before and after changing the accounting degree. Note that the output of the voice and the display color changing process are not indispensable requirements for the present invention. Therefore, neither the output of the voice nor the display color changing process may be executed, and any one of these processes may be carried out.

According to the first embodiment, the user operates the terminal device 1 and registers the accounting mode of which the accounting value is desired to be displayed with respect to the communication service to which the accounting modes of the plurality of categories can be applied. Then, the accounting value display screen 17 showing the accounting value of the registered accounting mode is displayed on the LCD 9 of the terminal device 1 during the communication service concerned.

This display enables the subscriber to grasp in realtime the accounting value of every accounting mode with respect to a given communication service. Accordingly, the subscriber is able to compare the accounting value (which is [Rate accounting based on packet quantity] in this example) of the default accounting mode with the accounting value (which is [Rate accounting based on packet count] in this example) of a accounting mode other than the default accounting mode. The subscriber is thereby able to grasp an optimum accounting mode (which implies, e.g., a minimum fee).

Further, according to the first embodiment, the accounting value display process is executed for every call (communication) of the communication service. Namely, the accounting value per call is displayed on the display of the terminal device 1. Therefore, the subscriber is able to grasp the optimum accounting value per call (communication) with respect to each communication service applicable on the terminal device 1.

The first embodiment discussed above takes the configuration by which the subscriber of the terminal device 1 registers the accounting mode each time the communication starts. Instead, it may take a configuration by which the accounting mode registered beforehand in the terminal device 1 is used each time the communication starts. In this case, a configuration may be such that the information of the accounting mode is printed on the memory module 4 of the terminal device 1, and also such that if the subscriber registers the accounting mode as an initial setting, the registration process becomes unnecessary when the communication starts thereafter. in this case, the registered content may be changed by a special process.

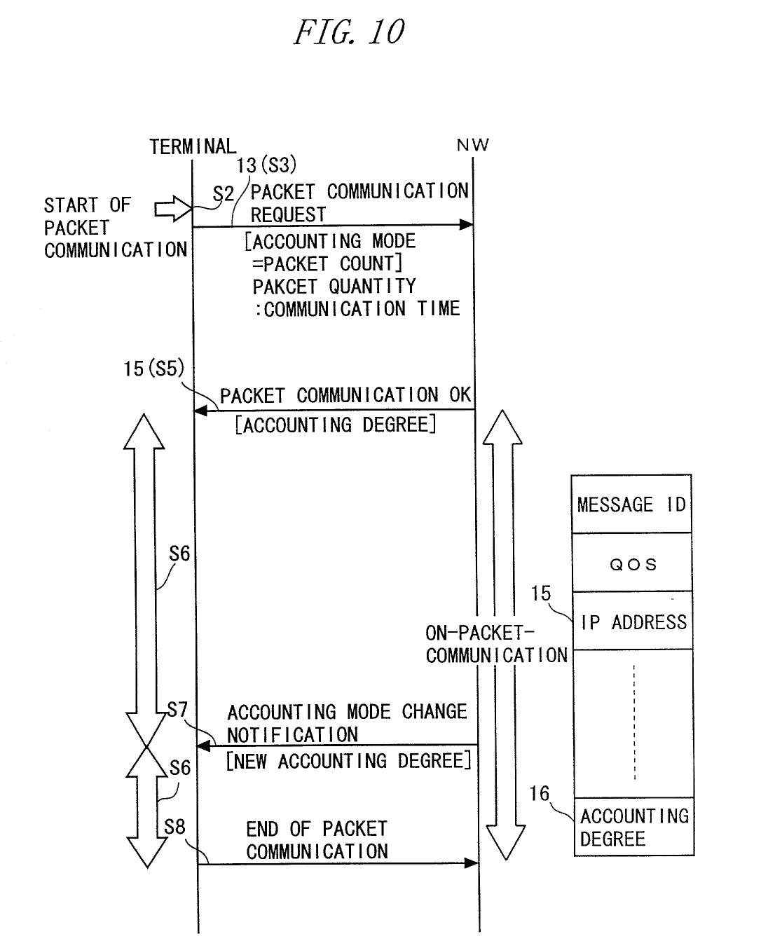

In the case of adopting the configurations given above, as shown in FIG. 10, when the subscriber starts the packet communication by operating the terminal device 1, the packet communication request message 13 containing the filed 16 is transmitted to the network without executing the registration process described above. Thereafter, the same operations as those explained above are performed, and the accounting value display screen 17 is displayed on the LCD 9 of the terminal device 1. Even in this case, the accounting value can be comparatively displayed for every call.

Further, according to the first embodiment, the accounting mode information and the accounting-basis information are registered on the SIM card 11, however, the accounting mode and the accounting degree may be registered on the memory module 4 without using the SIM card 1l. When adopting the configuration by which pieces of information on the accounting mode and on the accounting degree are recorded on the memory module 4, the SIM card 11 is not required. Note that the terminal device in the following embodiments may be structured to include the SIM car 11 as a recording medium.

[Second Embodiment]

Next, a second embodiment of the present invention will be discussed. The second embodiment has the common points to the first embodiment, and therefore the discussion will be focused on different points while the explanations of the common components marked with the same numerals are omitted.

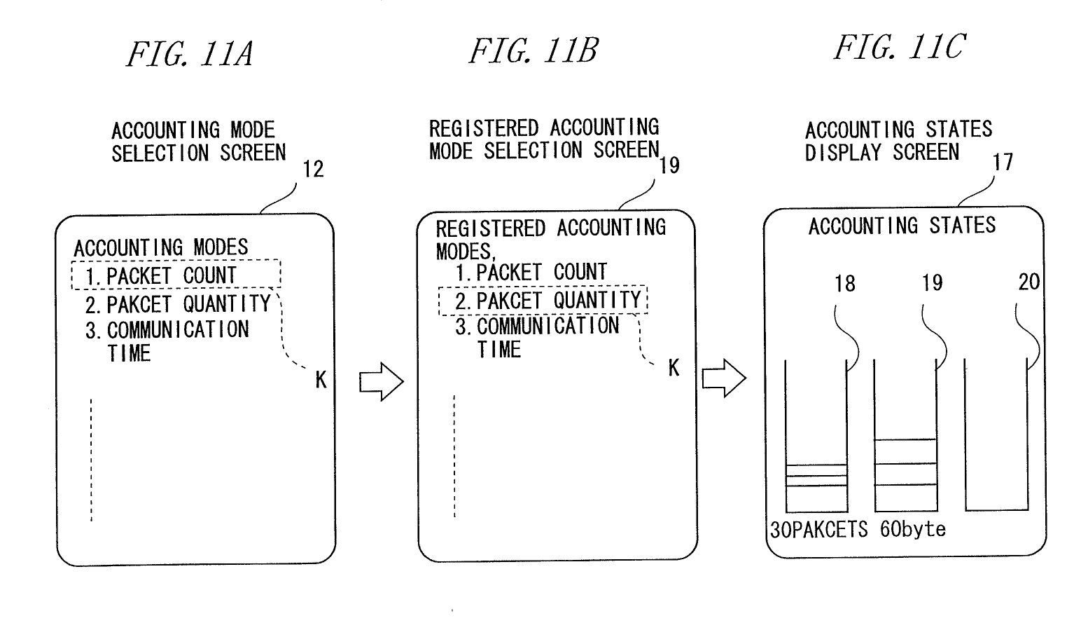

FIG. 11(A) is a diagram showing an example of the accounting mode selection screen 12 in the second embodiment. FIG. 11(B) is a diagram showing an example of a registered accounting mode selection screen 19. FIG. 11(C) is a diagram showing an example of an accounting value display screen 17 in the second embodiment.

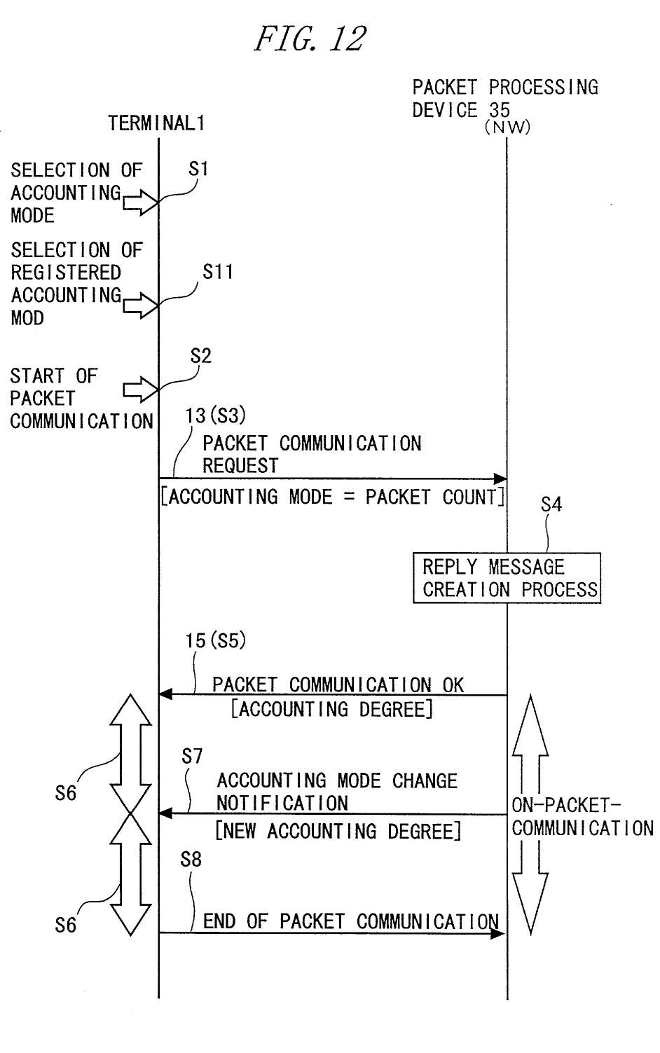

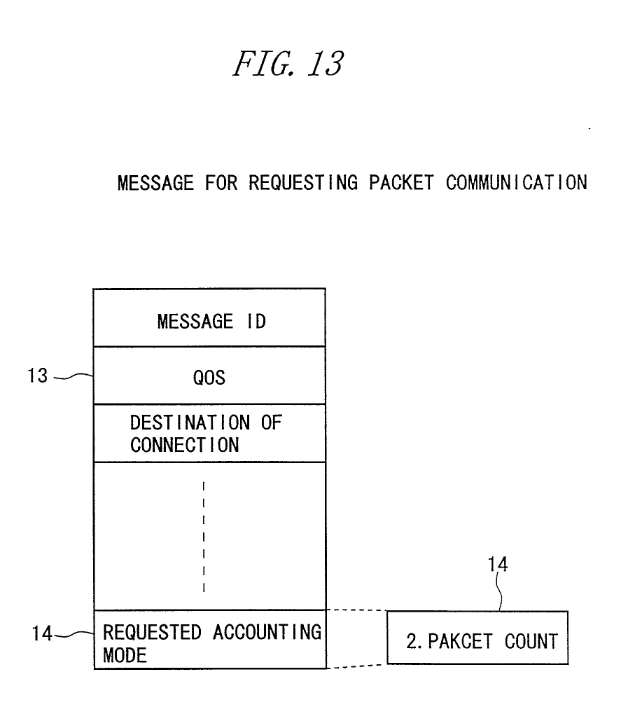

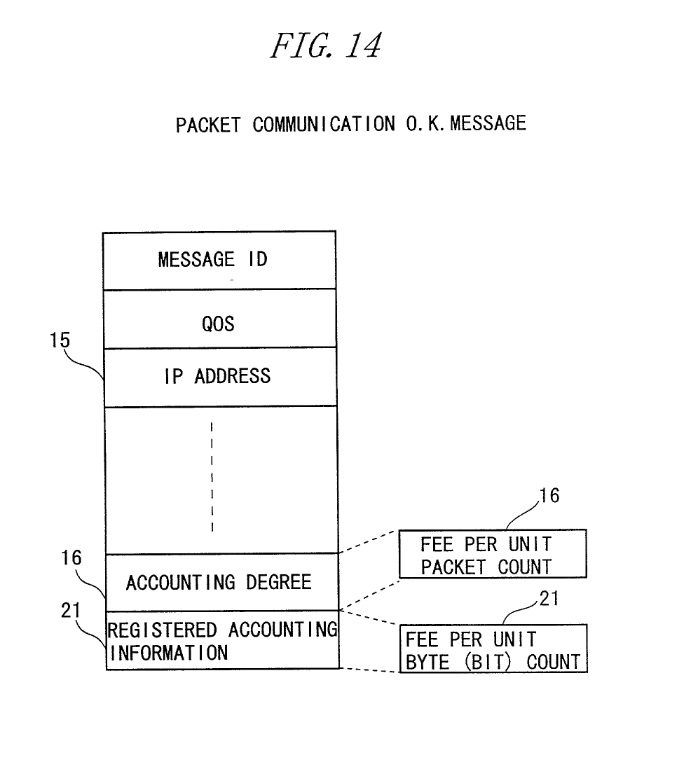

FIG. 12 is a sequence diagram showing an operational example of the system in the second embodiment. FIG. 13 is an explanatory diagram showing a packet communication request message in the second embodiment. FIG. 14 is an explanatory diagram showing a packet communication “OK” message in the second embodiment.

The operational example of the system in the second embodiment will hereinafter be described explained. In the second embodiment, the subscriber invokes the accounting mode selection screen 12 (see FIG. 1(A)) by use of the terminal device 1, and selects an accounting mode in which accounting values should be displayed (step S1).

At this time, the subscriber selects and registers the accounting mode excluding the default accounting mode. In this example, it is assumed that the subscriber selects [Rate accounting based on packet quantity] as a default accounting mode, and registers, e.g., [1. Packet count (Rate accounting based on packet count)] as the accounting mode other than the default accounting mode.

Upon an end of the registration process described above, subsequently the registered accounting mode selection screen 19 (see FIG. 11(B)) is displayed on the LCD 9 by the control unit 2 and the display unit 5. The registered accounting mode selection screen 19 has substantially the same screen layout as the accounting mode selection screen 12.

The subscriber manipulates the cursor K displayed on the screen 19, thus selecting the default accounting mode (step S11) In this example, the subscriber selects [2. Packet quantity] corresponding to the default accounting mode. The selected accounting mode is registered on the memory module 4.

Thereafter, the terminal device 1 sends, to the network NW, the packet communication request message 13 (see FIG. 13) in which the accounting mode (e.g., [1. Packet count]) other than the default accounting mode is set in the field 14 (S3).

The packet processing device 35 in the network NW, when receiving the message 13, as in the first embodiment, executes a process (step S4: see FIG. 6) of creating a reply message 15 (see FIG. 14). At this time, unlike the first embodiment, the following processes are to be executed. Specifically, the network NW (e.g., the packet processing device 35 in the network NW) obtains information on a content of a contract of the subscriber concerned out of the subscriber database 29, wherein a unique piece of information (e.g., a telephone number), contained in the message 13, for identifying the subscriber is used as a key. The network NW then specifies [Rate accounting based on packet quantity] as the default accounting mode on the basis of the obtained information on the content of the contract.

Subsequently, the network NW creates a parameter of the accounting degree corresponding to the specified default accounting mode, and stores this parameter in a field 21 as a parameter area provided afresh in the reply message 15.

Further, the network NW, as in the first embodiment, stores the field 16 with a parameter of the accounting degree corresponding to the accounting mode (e.g., [1. Packet count]) registered through on the screen 12.

Thus, according to the second embodiment, even when the parameter of the default accounting mode is not stored in the message 13, the network NW creates the reply message 15 stored with the accounting degree information (on the accounting degree of the accounting mode selected when the contract is agreed upon) corresponding to the default accounting mode, and transmits the message 15 to the terminal device 1.

The terminal device 1, upon receiving the reply message 15, executes substantially the same process as the accounting value display process shown in FIG. 7, and displays the accounting values of [1. Packet count] and [2. Packet quantity] on the accounting value display screen 17 (see FIG. 11(C)). A display mode on the accounting value selection screen 17 is, however, different from in the first embodiment.

To be specific, on the accounting value selection screen 17 in the second embodiment 17, the indicator (corresponding to [2. Packet quantity] in this example) corresponding to the (default) accounting mode selected on the registered accounting mode selection screen 19, is displayed in a mode distinguishable from other indicators. For instance, the [2. Packet quantity] indicator itself or the bar graph indicating an accounting quantity of the indicator is displayed in a more enhanced (conspicuous) mode than other indicators. The enhancement mode may involve, for example, displaying it in a color (e.g., highlight) different from other indicators. This enhancement mode enables the subscriber to precisely grasp the accounting value of the default accounting mode, thereby facilitating comparisons with other accounting modes.

As a matter of course, in contrast with the enhancement mode given above, the accounting mode selected on the accounting mode selection screen 12 may also be displayed in a more enhanced (conspicuous) than the accounting mode selected on the registered accounting mode selection screen 19.

According to the second embodiment, as in the first embodiment, each of the accounting values of the accounting modes of the plurality of categories can be displayed per call on the display of the terminal device 1. Especially in the second embodiment, the accounting value of the default accounting mode can be displayed per call in the display mode distinguishable from the accounting values of other accounting modes. At this time, the accounting value (of the indicator) of the default accounting mode is displayed in the more enhanced display mode than other accounting values (of other indicators), thereby making it easier for the subscriber to compare with others.

[Third Embodiment]

Next, a third embodiment of the present invention will be discussed. The third embodiment has the common points to the first embodiment, and therefore the discussion will be focused on different points while the explanations of the common components marked with the same numerals are omitted.

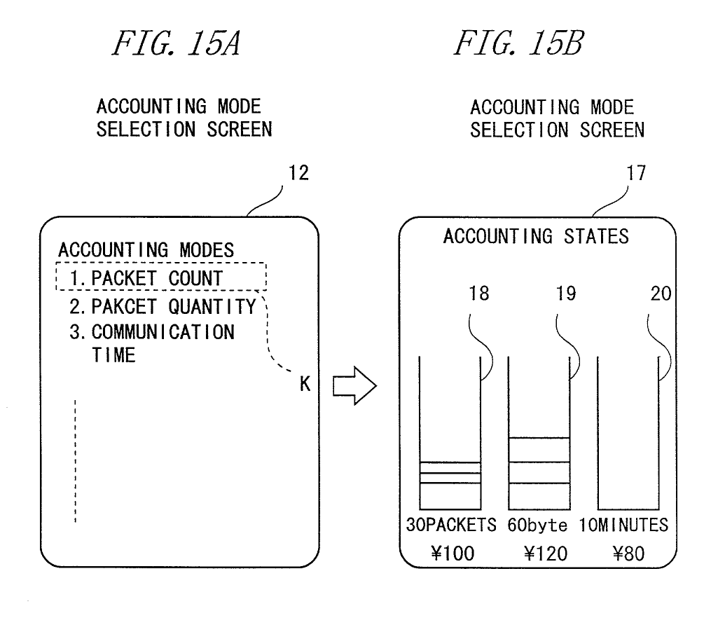

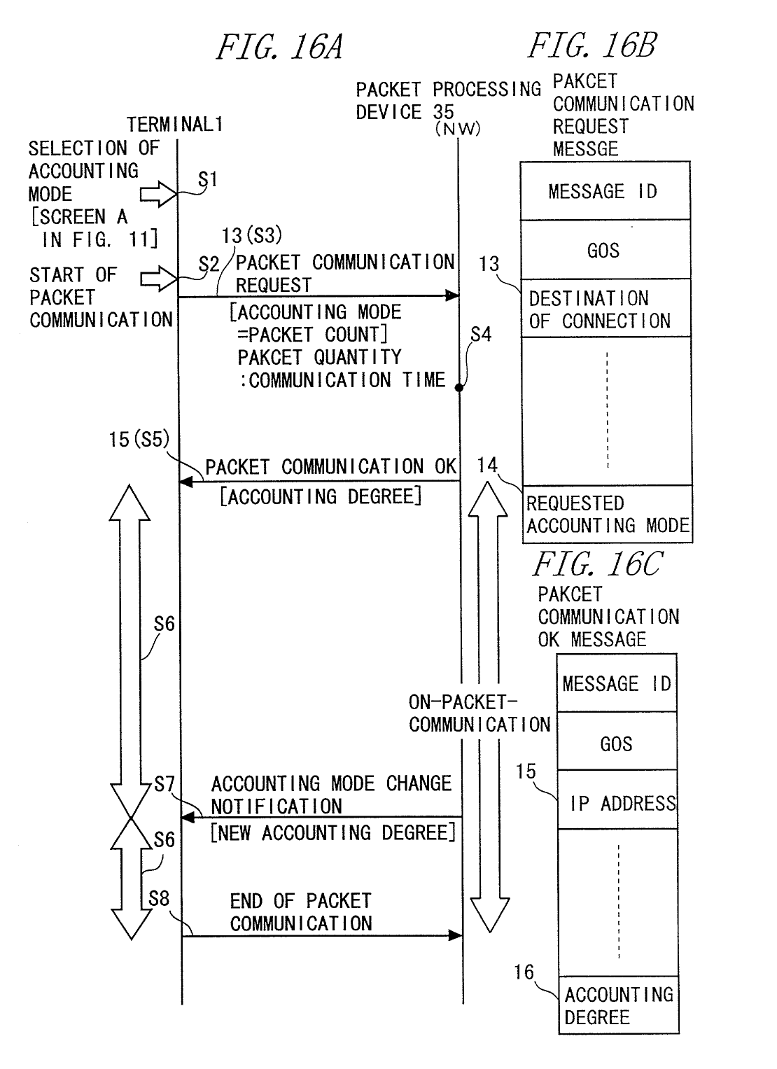

FIG. 15(A) is a diagram showing an example of the accounting mode selection screen 12 in the third embodiment. FIG. 15 (B) is a diagram showing an example of the accounting value display screen 17 in the third embodiment. FIG. 16(A) is a sequence diagram showing an operational example of the system in the third embodiment. FIG. 16(B) is an explanatory diagram of the packet communication request message 13 in the third embodiment. FIG. 16(C) is an explanatory diagram showing the packet communication “OK” message (reply message) 15 in the third embodiment.

The accounting value display process (see FIG. 8) in the terminal device after receiving the reply message 15 in third embodiment, is different from that in the first embodiment. To be specific, according to the first embodiment, the control unit 2 obtains, based on the information of the accounting degree, the accounting quantity corresponding to the accounting mode in step S63. In the third embodiment, the control unit 2 obtains the accounting quantity and further an actual fee (an amount of money) in step S63.

Then, the control unit 2 and the display unit 5 display the accounting values, i.e., the accounting quantities of the respective accounting modes by use of the indicators 18˜20 on the accounting value display screen 37. The control unit 2 and the display unit 5 also displays the amounts of fees in the respective accounting modes in relation to the indicators 18˜20 (step S64: see FIG. 15(B)). Excluding the points described above, the third embodiment has the same configuration as the first embodiment.

According to the third embodiment, as in the first embodiment, the accounting values of the accounting modes of the plurality of categories can be displayed on the display of the terminal device 1. At this time, in addition to the accounting quantity of every accounting mode, the specific amount of money is also displayed. This contrivance enables the user (the subscriber of the communication service) to clearly grasp a difference in amount of money between the accounting modes.

[Fourth Embodiment]

Next, a fourth embodiment of the present invention will be discussed. The fourth embodiment has the common points to the first embodiment, and therefore the discussion will be focused on different points while the explanations of the common components marked with the same numerals are omitted.

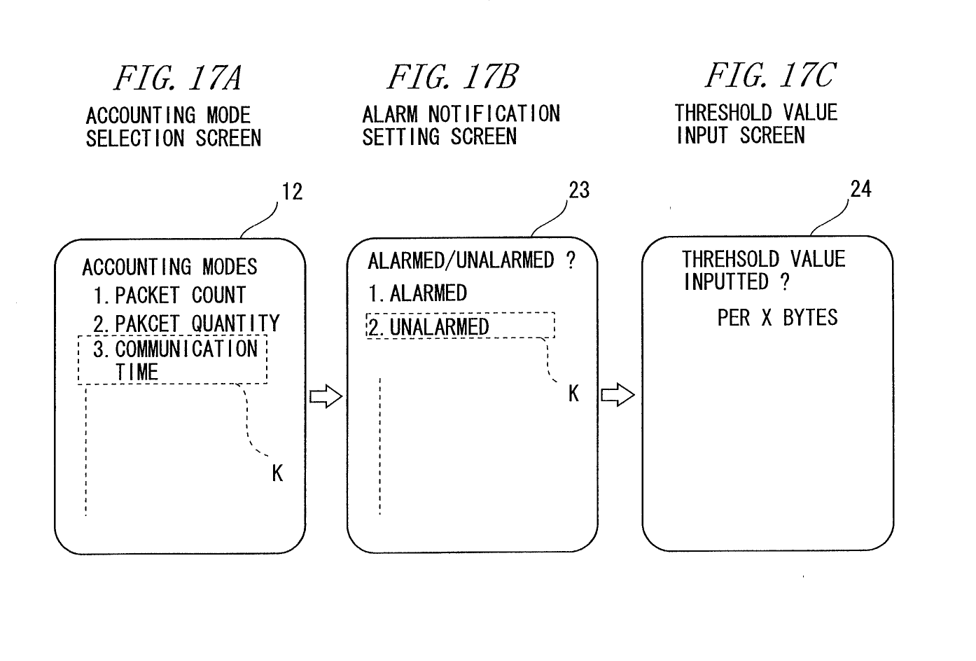

FIG. 17(A) is a diagram showing an example of the accounting mode selection screen 12 in the fourth embodiment. FIG. 17 (B) is a diagram showing an example of an alarm notification setting screen 23. FIG. 17(C) is a diagram showing an example of a threshold value input screen 24.

In the fourth embodiment, as shown in FIG. 17 (A), the user (subscriber) of the terminal device 1 invokes the accounting mode selection screen 12 and selects and registers the accounting mode (step S1: see FIG. 4). The accounting mode to be registered may be a default accounting mode or a mode other than the default. Herein, it is assumed that the default accounting mode is selected and registered by way of an example.

Thereafter, the subscriber manipulates the operation key 10 and presses a call button for the alarm notification setting screen 23 (see FIG. 17(B). Then, the control unit 2 and the display unit 5 displays the alarm notification setting screen 23 on the LCD 9.

The alarm notification setting screen 23 is a setting screen for setting of making an alarm notification occur at an interval of a predetermined threshold value. In an example shown in FIG. 17(B), an indication of setting whether the alarm notification is given or not is displayed on the screen 23.

The subscriber selects and determines one of [1. Alarmed] and [2. Unalarmed] displayed as options on the screen 23 by manipulating the cursor K, whereby the alarm notifying function can be set ON or OFF. That is, if the subscriber selects [1. Alarmed], the alarm notifying function is set ON. Whereas if selecting [2. Unalarmed], the alarm notifying function is set OFF.

When the subscriber selects [1. Alarmed] on the screen 23, the control unit 2 and the display unit 5 display the threshold value input screen 24 (see FIG. 17 (C)) in place of the screen 23 on the LCD 9. The subscriber inputs a threshold value corresponding to the registered accounting mode on the threshold value input screen 24.

For instance, if the registered accounting mode is [Packet quantity], the subscriber inputs a predetermined byte count as a threshold value. Further, if the registered accounting mode is [Packet count] , the subscriber inputs a predetermined packet count as a threshold value. Moreover, if the registered accounting mode is [Communication time], the subscriber inputs a predetermined time as a threshold value. The threshold values inputted on the screen 24 are recorded on the memory module 4.

Thereafter, when the subscriber performs the packet communication by operating the terminal device 1, as in the first embodiment, the accounting value display process (see FIG. 8) is executed. In the fourth embodiment, the control unit 2 counts the accounting element corresponding to the accounting mode, and compares the count value of the accounting element with a threshold value recorded on the memory module 4. Each time the count value exceeds a multiple of the threshold value, makes the voice I/O unit 7 output an audible tone as an alarm notification. For instance, if the subscriber sets the threshold value to [1 mega-bytes], each time the packet quantity exceeds 1 mega-bytes, the audible tone is outputted, and the user is thus notified of the alarm.

In the fourth embodiment also, the accounting value display screen 17 is displayed, and the indicator corresponding to the accounting mode agreed upon is displayed on the screen 17. The accounting quantity indicated by the indicator is displayed in a different display mode each time the count value exceeds the multiple of the threshold value. For example, the accounting quantity is displayed in a different color. That is, the subscriber is notified of a change in the display mode of the accounting quantity as an alarm. Note that if the LCD 9 is monochromatic, the display mode may be changed (e.g., a dot density in a half-tone dot meshing display is changed).

Note that the alarm as an indication of being charged a fee can be transferred to the subscriber by methods such as vibrations using a vibrator function incorporated into a mobile telephone, lightening (flickering, extinguishing) of a lamp and so on, in addition to the output of the voice and the display on the screen.

Further, the method of inputting one threshold value has been exemplified above, however, there may also be taken a method of inputting a plurality of threshold values and notifying the subscriber of the alarm each time the count value exceeds each threshold value. Further, the threshold value is set with respect to the accounting element and may also be set with respect to the accounting quantity.

In accordance with the fourth embodiment, each time the accounting element (the count value) of the accounting mode registered through on the screen 12 is over the predetermined threshold value, the subscriber is notified of the alarm (the output of the audible tone, the display mode of the accounting quantity). The subscriber is, when notified of the alarm, able to get a recognition of being charged a fee.

Herein, if the accounting mode registered is a default accounting mode, the subscriber can get a comprehension of being actually charged the fee each time the subscriber is notified of the alarm. By contrast, if an accounting mode other than the default is registered, the subscriber can make a test of how the service is charged a fee in the registered accounting mode by receiving the alarm notification.

The fourth embodiment has the following advantages. If the rate accounting is selected in the packet communication service, there might arise the following cases where the service is charged a fee while the subscriber is not aware of it.

(1) When the subscriber opens a chat screen, the chat screen might be rewritten by a speech etc of other chat participant even though the subscriber inputs nothing. On the occasion of rewriting the chat screen, the packets are transmitted and received, with the result that the accounting quantity increases. At this time, if the subscriber is not aware of the char screen being rewritten, the packet communication service is charged a fee while the subscriber does not recognize it.

(2) Alternatively, if the subscriber boots a mailer, the mailer periodically forwards the packet of a request for receiving the E-mail in accordance with POP (Post Office Protocol). The subscriber is not aware of this packet forwarding in many cases.

According to the fourth embodiment, the alarm notification is issued to the subscriber, and the subscriber is thus known well of being charged the fee. Therefore, the above-described cases of being charged the fee while the subscriber is unaware of it can be reduced.

Further, in the fourth embodiment, the accounting value is displayed in realtime. Therefore, the subscriber, if not desiring a continuation of the communication when notified of the alarm, may disconnect the communication. The increase in the accounting quantity can be thereby restrained.

[Fifth Embodiment]

Next, a fifth embodiment of the present invention will be discussed. The fifth embodiment has the common points to the third embodiment, and therefore the discussion will be focused on different points while the explanations of the common components marked with the same numerals are omitted.

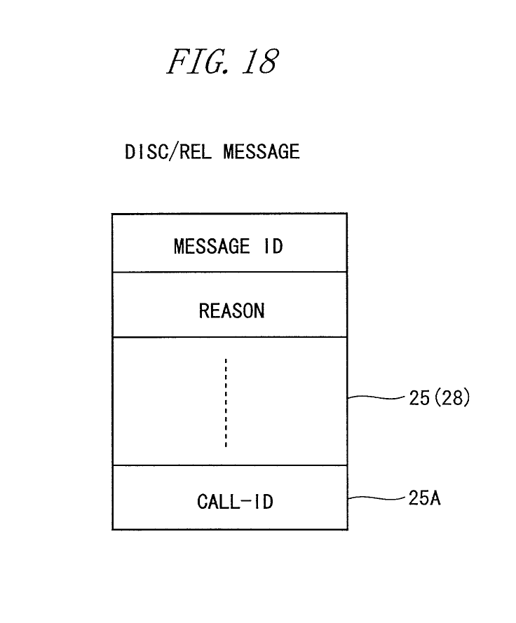

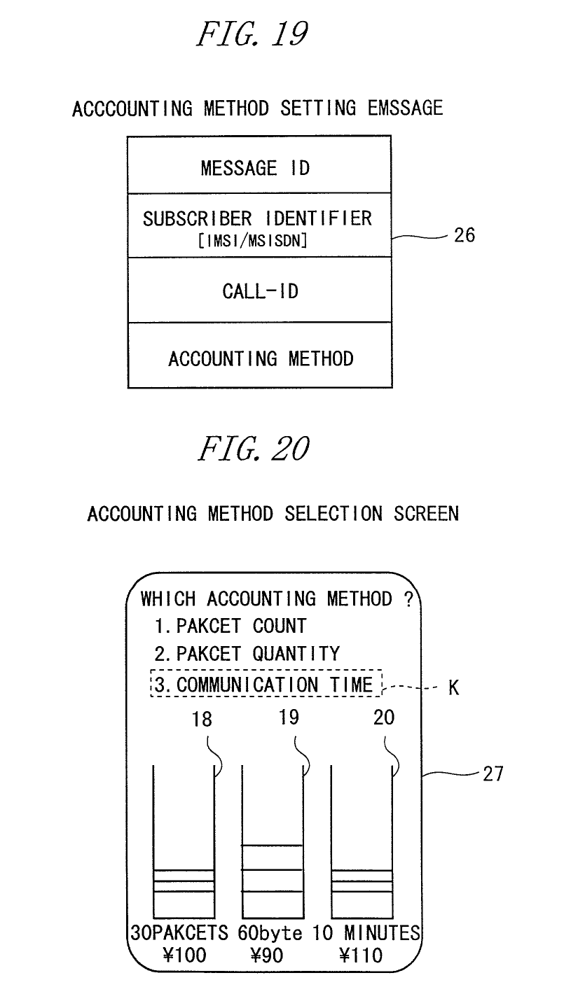

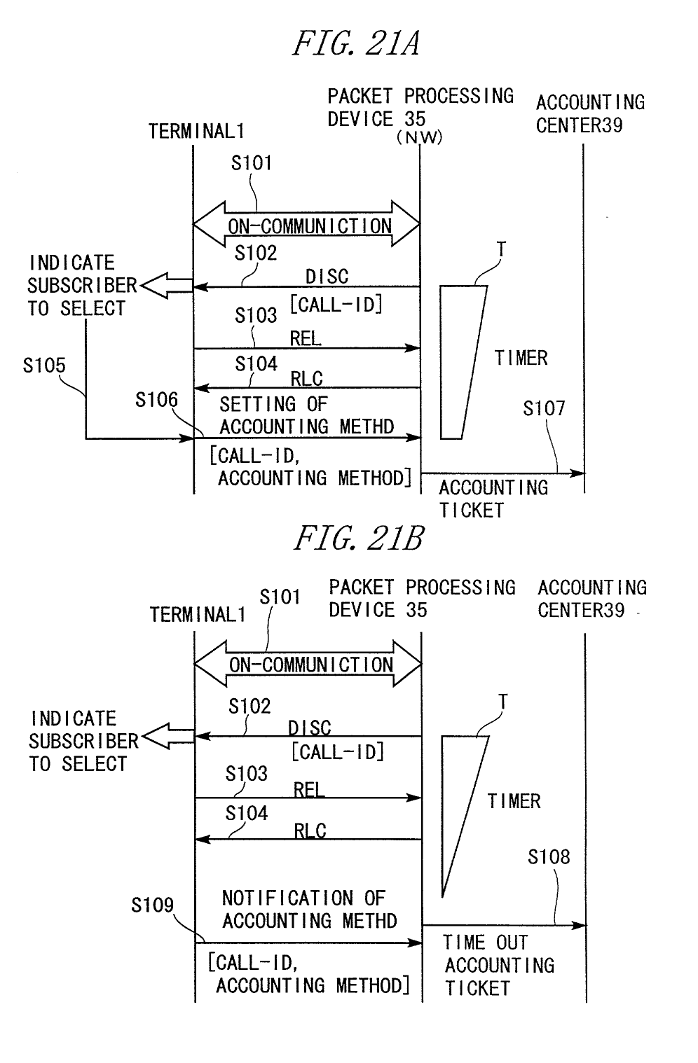

FIG. 18 is an explanatory diagram showing a format of a DISC/REL message 25. FIG. 19 is an explanatory diagram showing a format of an accounting method setting message 26. FIG. 20 is a diagram showing an example of an accounting method selection screen 27. Further, FIGS. 21(A) and 21(B) are sequence diagrams each showing an example of an operation for selecting an accounting method in the terminal device 1.

An operational example of the system in the fifth embodiment will hereinafter be described referring to FIGS. 21(A) and 21(B). Referring to FIG. 21(A), during the communication between the terminal device 1 and the network NW (the on-duty status of the communication service: step S101), the accounting value of each accounting mode registered by the subscriber in the terminal device 1 is displayed on the display of the terminal device 1 in the same processes as steps S1˜S6 explained in the third embodiment.

Thereafter, when finishing the communication (speech, call), the network NW (e.g., the packet processing device 35 in the network NW) transmits a DISC (DISCONNECT) message 25 (or a REL (RELEASE) message 28) (see FIG. 18) defined as a call disconnection signal to the terminal device 1 (step S102).

The DISC message 25 has a new parameter area (field) 25A stored with a call identification number (CALL-ID) for the subscriber to select an accounting method.

The network NW, when transmitting the DISC message 25, sets a timer T for counting a time for which to permit a receipt of an accounting method setting message 26 (see FIG. 19) from the terminal device 1.

The terminal device 1, when receiving the DISC message 25, transmits to the network NW the REL message 28 (having the same format as the DISC message 25: see FIG. 18) (step S103). The network NW, when receiving the RELE message 28, transmits to the terminal device 1 a REC (RELEASE COMPLETE) message defined as a message showing a completion of the call release process (step S104). Thus, the call disconnection process is executed.

On the other hand, the terminal device 1, when receiving the DISC message 25, executes a process for indicating the subscriber (of the communication service) to select the accounting method (step S105).

Namely, the control unit 2 records on the memory module 4 a CALL-ID contained in the message 25 received from the network NW. This CALL-ID may be displayed on the LCD 9.

Next, the control unit 2 and the display unit 5 display the accounting method selection screen 27 on the LCD 9. In an example shown in FIG. 20, the options such as [1. Packet count] [2. Packet quantity] and [3. Communication time] are displayed together with a character string [Which accounting method?] on the accounting method selection screen 27. The subscriber can select any one of these options by manipulating the cursor K displayed on the screen 27.

Further, the indicators 18 20 displayed on the accounting value display screen 17 (see FIG. 15 (B)) explained in the third embodiment and amounts of money corresponding to the respective accounting modes, are displayed on the screen 27. Namely, the accounting values (accounting quantities, amounts of money) corresponding to the respective accounting modes counted substantially simultaneously when finishing the communication of this time, are displayed on the screen 27.

This display mode enables the subscriber to select the accounting mode while referring to the indicators 18˜20 and the amounts of money. Accordingly, the subscriber can accurately select the accounting mode (exhibiting, e.g., the minimum amount of money) desired by the subscriber himself or herself,

Note that the accounting method selection screen 27 may be configured as a separate screen from the accounting information display screen 17, and may also configured so that the inquiry sentence and the options shown in FIG. 20 are displayed on the screen 17 shown in FIG. 14(B) with a trigger that the terminal device 1 receives the DISC message 25.

When the accounting method is chosen, the control unit 2 creates the accounting method setting message 26 (see FIG. 18). A subscriber's identifier (IMSI/MSISDN), the CALL-ID contained in the message 25 and the selected accounting method, are respectively set in the message 26. The created message 26 is sent to the network NW (step S106).

The network NW (precisely, the packet processing device 35), if receiving the message 26 before (the timer T comes to time-out) the receipt allowable time of the message 26 elapses, issues and transmits to the accounting center 39 an accounting ticket including a set of information such as the subscriber's identifier (the unique information for identifying the subscriber), the CALL-ID (the information for identifying the call (communication service) and the information on the accounting method selected by the subscriber which are contained in the message 26, and another set of information such as values (e.g., a packet quantity, a packet count and a communication time) of the accounting elements corresponding to the accounting method and an accounting degree (step S107).

The accounting center 39, when receiving the accounting ticket, charges (calculates) a fee based on the accounting method (accounting mode) selected by the subscriber with respect to the concerned call (communication service) of the present subscriber by use of the information contained in the accounting ticket.

Accordingly, the subscriber can pay the fee for the call (the fee for using the communication service) by the accounting method selected by the subscriber himself or herself. It is therefore feasible for the subscriber to pay the fee for using the communication service by the accounting method (the accounting mode) that minimizes the fee.

By the way, as shown in FIG. 21 (B), if the subscriber does not intentionally select the accounting method (if the subscriber does not transmit the message 26), the timer T comes to time-out. Then, the network NW (precisely, the packet processing device 35) obtains the information on the default accounting mode from the subscriber database 29 stored with the content of the contract for the subscriber's using the communication service, and issues and transmits to the accounting center 39 the accounting ticket containing the information on the default accounting mode (step S108).

The accounting center 39, in the same way as the above, calculates a fee for the present call (the communication service) on the basis of the default accounting mode by use of the information contained in the accounting ticket received. Thus, if the network NW does not receive the message 26 before the timer T comes to time-out, the call is charged a fee based on the default accounting mode.

Hence, the subscriber, if the fee based on the default accounting mode proves to be optimal (e.g., lowest) as a result of having referred to the screen 27, may not select other accounting methods. As a matter of course, the subscriber may positively select the default accounting mode on the screen 27.

On the other hand, the network NW, if the timer T comes to time-out, creates an accounting method notifying message indicating that the accounting ticket with the default accounting mode selected has been issued, then gets the CALL-ID and the default accounting mode (the accounting method) contained in this message, and sends the message to the terminal device 1 (step S108).

Note that the network NW may also send to the terminal device 1 a short message (SM) showing that the call is charged a fee in the default accounting mode, as a substitute for the accounting method notifying message.

According to the fifth embodiment, it is possible to give the subscriber a width of options of the accounting modes such as selecting which mode, the packet rate accounting mode or the time-basis accounting mode, with respect to the communication service exhibiting, for instance, a characteristic that the communication is, though coming under the voice communication as on VOIP, categorized as the packet communication. The subscriber selects the accounting mode when finishing the communication, which leads to the selection of the optimum accounting mode, whereby the fee for the communication can be restrained lowest.

[Sixth Embodiment]

Next, a sixth embodiment of the present invention will be discussed. The sixth embodiment has the common points to the first embodiment, and therefore the discussion will be focused on different points while the explanations of the common components marked with the same numerals are omitted.

The discussion in the sixth embodiment concerns a method (of registering the accounting mode for every category of call) by which the user (the subscriber of the plurality of communication services using the network NW) of the terminal device 1 operates the terminal device 1 and registers the subscriber database 29 connected to the network NW with the accounting mode (the accounting method) corresponding to each of the plurality of communication services utilizable by the subscriber through the operation of the terminal device 1.

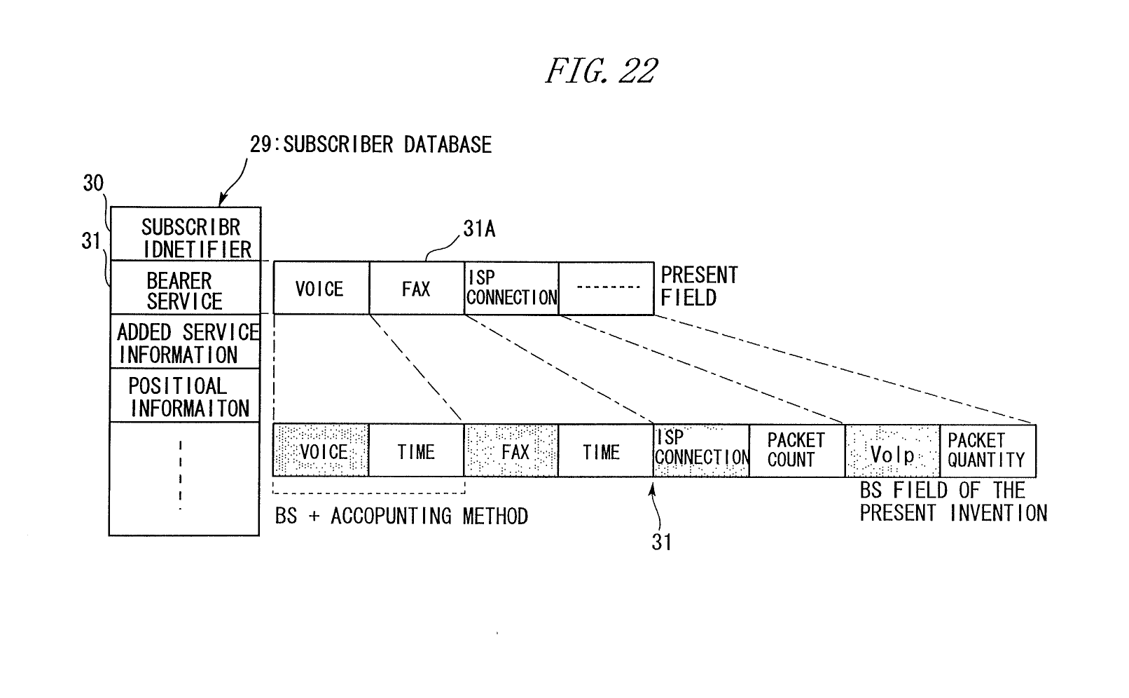

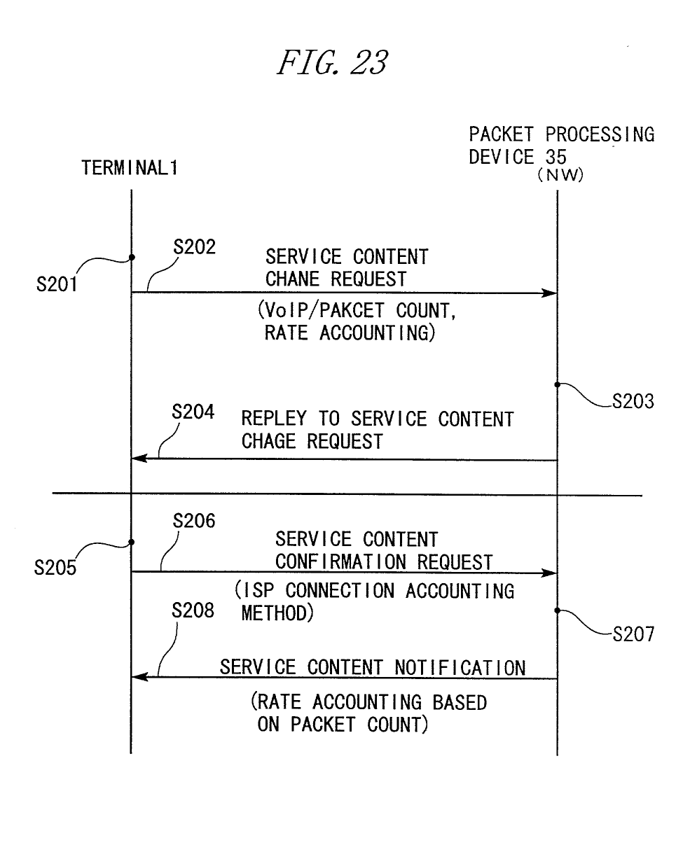

FIG. 22 is an explanatory diagram showing the subscriber database 29 in the sixth embodiment. FIG. 23 is a sequence diagram showing an operational example (the accounting method for the communication service) of the system in the sixth embodiment. As shown in FIG. 22, the subscriber database 29 contains a field 30 for storing a subscriber identifier and a field 31 for storing a bearer service.

The conventional field 31 has hitherto been, as in a field 31A shown in FIG. 22, stored with only a call category utilizable by the subscriber. By contrast, the field 31 in the sixth embodiment of the present invention is stored with the call category coupled with an accounting mode (accounting method) corresponding to this call category.

In the example shown in FIG. 22, the field 31 is stored (registered) with a call category [Voice communication] coupled with an accounting mode [Time-basis accounting], and a call category [FAX] coupled with the accounting mode [Time-basis accounting] . The field 31 is further stored (registered) with a call category [Internet Service Provider (ISP) connection] coupled with an accounting mode [Rate accounting based on packet count]. Moreover, the field 31 is stored (registered) with a call category [VOIP] coupled with an accounting mode [Rate accounting based on packet quantity].

Next, an operational example of the sixth embodiment will be explained referring to FIG. 23. The subscriber, when desiring to change the accounting mode with respect to, e.g., the call category [VoIP], operates the terminal device 1 and creates a service content change request message (step S201). The service content change request message contains a subscriber identifier, a piece of information (call category) for specifying the communication service of which the accounting mode is requested to be changed, and a piece of information for specifying an accounting mode after being changed. The created service content change request message is transmitted from the terminal device 1 to the network NW (step S202).

The network NW, when receiving the service content change request message, extracts the subscriber identifier , the communication service specifying information and the accounting mode specifying information which are contained in this message, and updates the field 31 of the subscriber database 29 in accordance these extracted pieces of information (step S203).

In this example, the accounting mode [Rate accounting based on packet quantity] stored in relation to the communication service [VOIP] is rewritten into [Rate accounting based on packet count].

The network NW, when updating the subscriber database 29, creates a service content change reply message and sends it back to the terminal device 1. The terminal device 1 is thereby capable of knowing that the accounting mode corresponding to the communication service [VOIP] has been changed.

Thus, the subscriber is able to change (or newly register) the information on the accounting mode corresponding (related) to the communication service that is stored on the subscriber database 29.

On the other hand, the subscriber, when desiring to confirm the accounting mode corresponding to a given communication service that is registered on the subscriber database 29, operates the terminal device 1 and creates a service content confirmation request message containing the subscriber identifier and the information for specifying the communication service of which the accounting mode is desired to be confirmed (step S205). Then, the subscriber sends this message to the network NW (step S206). It is assumed that the service content confirmation request message contains a piece of information for specifying, e.g., the communication service [ISP connection].

The network NW, when receiving the service content confirmation request message, extracts the subscriber identifier and the communication service specifying information from this message and reads, based on these pieces of information, the information [Rate accounting based on packet count] of the accounting mode corresponding to the communication service [ISP connection] from the subscriber database 29 (step S207).

Thereafter, the network NW creates a service content notifying message containing the readout information of the accounting mode, and transmits this message to the terminal device 1 (step S208). The terminal device 1, upon receiving the service content notifying message, displays the communication service [ISP connection] and the accounting mode [Rate accounting based on packet count] corresponding to this service category on the LCD 9. The subscriber is thereby able to, even when forgetting the registered accounting mode of a given communication service, confirm and comprehend the accounting mode through the processes described above.

The subscriber database 29 is, for example, used as follows. Namely, when the subscriber utilizes anyone of the communication services by operating the terminal device 1, at the end of the communication service (at the end of the communication), the network NW obtains the information on the accounting mode (the accounting method) corresponding to the utilized communication service from the subscriber database 29, and issues an accounting ticket obtaining the accounting mode (method) obtained. The accounting ticket issued is sent to the accounting center 39. The accounting center 39 executes a settlement process based on the information contained in the accounting ticket received.

According to the sixth embodiment, the user of the terminal device 1 can newly register or can update and register the accounting mode with respect to each of the utilizable communication services. Note that the field 31 of the subscriber database 29 maybe registered with accounting modes corresponding to WWW and E-mails serving as communication services.

Further, as a substitute for the configuration described above, the accounting center 39 may have a database registered with the accounting mode for every call category and, when receiving the accounting ticket from the network NW, may execute a settlement process by using pieces of information on accounting values registered in an unillustrated database.

Note that the configuration for displaying the accounting value per accounting mode with respect to one category of communication service explained in the first embodiment, is not an indispensable element for the sixth embodiment.

[Seventh Embodiment]

Next, a seventh embodiment of the present invention will be discussed. The seventh embodiment is what is embodied about a function service that enables the subscriber to select an accounting method when originating a call. The seventh embodiment has the common points to the first embodiment, and therefore the discussion will be focused on different points while the explanations of the common components marked with the same numerals are omitted.

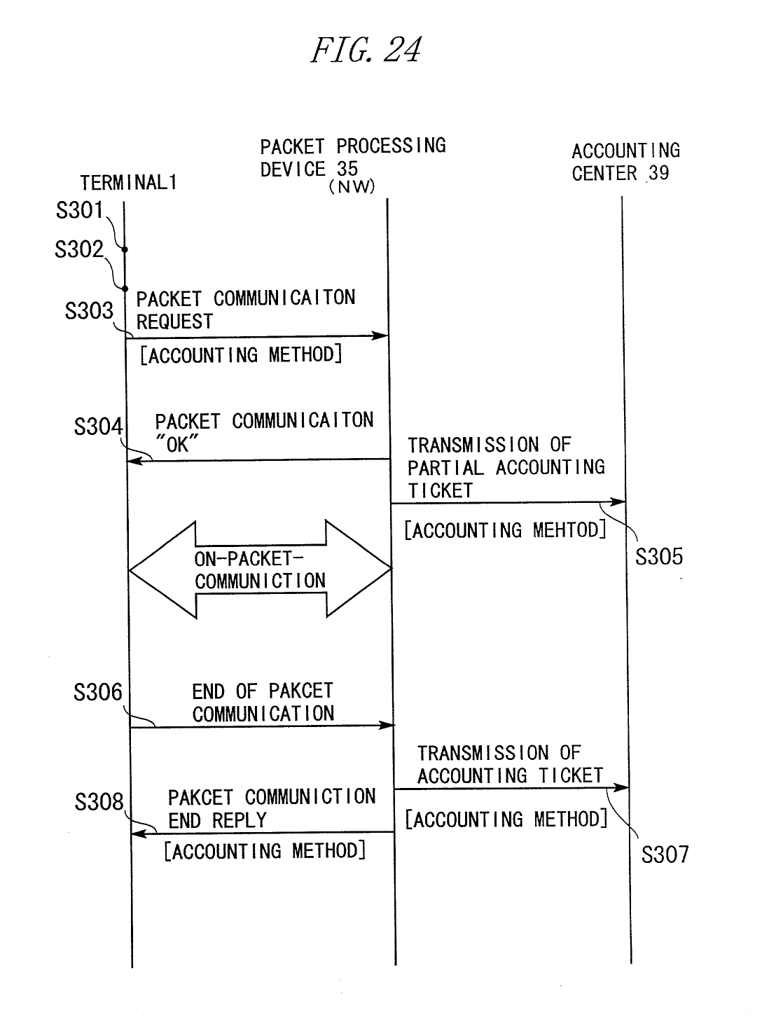

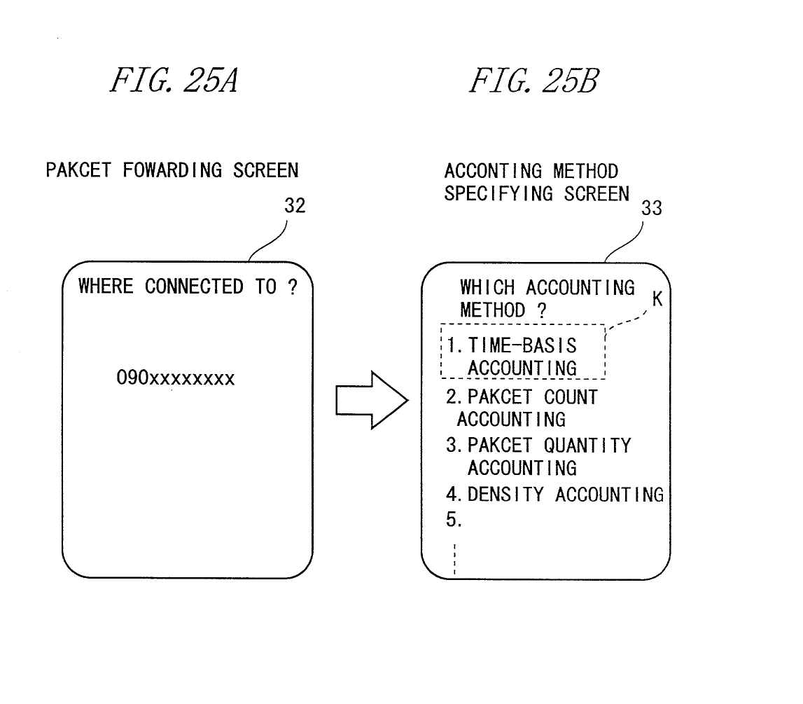

FIG. 24 is a sequence diagram showing an operational example (an accounting method for the communication service) of the system in the seventh embodiment. FIG. 25(A) is a diagram showing a display example of a packet forwarding screen 32. FIG. 25(B) is a diagram showing a display example of an accounting method specifying screen 33.

According to the seventh embodiment, the user (subscriber) of the terminal device 1, when utilizing the communication service, notifies beforehand the network NW of the accounting mode applied to the communication service concerned, wherein the service is charged a fee and a settlement is carried out based on the accounting mode of which the network NW has been notified.

Referring to FIG. 24, if the subscriber uses an E-mail as a given communication service and when desiring to previously specify the accounting mode (the accounting method) applied to a delivery of the E-mail of this time, the subscriber manipulates the operation key 10 on the terminal device 1, thus indicting the control unit 2 and the display unit 5 to display the packet forwarding screen 32 (FIG. 24(A)). The subscriber inputs on the screen 32 a telephone number of a destination terminal as a unique piece of information (an E-mail address of the destination terminal) on the connecting destination (step S301) Next, the subscriber indicates the control units 2 and the display unit 5 to display the accounting method specifying screen 33 (FIG. 24(B)) by manipulating the operation key 10. Accounting methods of a plurality of categories applicable to the E-mail are displayed on the screen 33. The subscriber selects any one of the accounting methods by manipulating the cursor K. It is assumed that the subscriber has selected, for example, [(Rate) Accounting based on packet quantity].

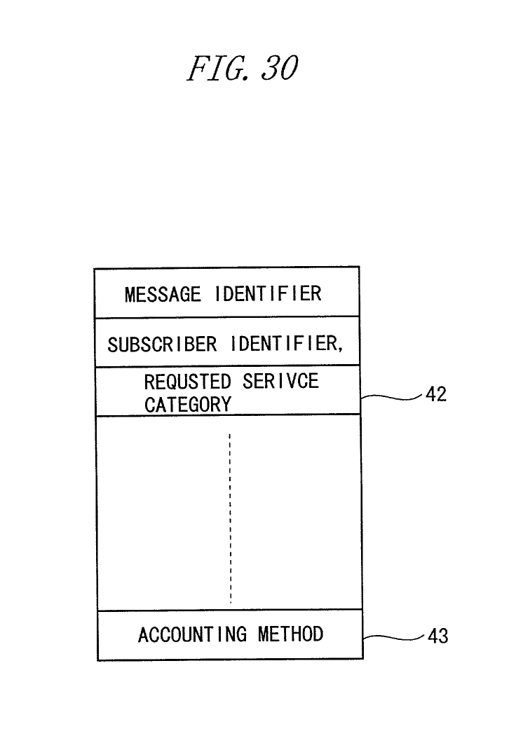

The information on the selected accounting method is stored in a field 43 provided afresh in a packet communication request message (a call setting message: SETUP in the case of the voice communication) 42 (see FIG. 30), and the terminal device 1 sends this message to the network NW (step S303).

The network NW (precisely, the packet processing device 35 in this example), when receiving the call setting message, registers the information on the accounting mode contained in the call setting message on the subscriber information database connected to the network NW. Further, the network NW, after executing a process for connecting a call relative to the packet communication (the delivery of the E-mail), sends the packet communication “OK” message (the reply message) back to the terminal device 1 (step S304).

When the terminal device 1 receives the reply message, the call (communication) originating from the terminal device 1 via the network NW is established, and there comes to an on-communication status (the on-duty status of the communication service). With this call established, the terminal device 1 delivers the E-mail to the network NW. the network NW, when the terminal device 1 moves from a certain zone to other zone, counts a packet quantity of the E-mail delivered from the terminal device 1 having existed in the previous zone. Then, the network NW issues a partial accounting ticket containing the packet quantity counted, the accounting mode and the user identifying information (the subscriber identifier), and transmits this ticket to the accounting center (step S305).

Thus, when the terminal device 1 moves over a plurality of zones, the network NW notifies the accounting center of a partial accounting ticket for the packet communication in each zone, and the fee for this packet communication is given as a sum of fees based on the plurality of partial accounting tickets.

Thereafter, the terminal device 1 finishes delivering the E-mail and, if it comes to an end of the packet communication, transmits a packet communication end message (a DISC or REL message) to the network NW (step S306).

The network NW (precisely, the packet processing device 35), upon receiving the packet communication end message, executes the call disconnection process, thereafter reads from the subscriber database 29 the information on the accounting method applied to the packet communication of this time, and issues and transmits the accounting ticket (or the partial accounting ticket) containing the information on the readout accounting method to the accounting center 39 (step S307).

Note that the accounting ticket is created and transmitted if the terminal device exists in the same zone throughout the packet communication from the beginning to the end. The accounting center settles a feed for utilizing the packet communication of this time on the basis of the plurality of partial accounting tickets or the accounting ticket received from the network NW.

Further, the network NW creates and sends the packet communication end message to the terminal device 1 (step S308). At this time, the packet communication end message contains the accounting method applied to the packet communication of this time.

In the terminal device 1, when receiving the packet communication end message, a notification that the packet communication of this time has been charged the fee based on the previously selected accounting method, is displayed on the LCD 9. The subscriber is thereby able to know that the packet communication (the communication service) of this time has been charged the fee based on the accounting method selected by the subscriber himself or herself.

The operational example given above has dealt with the case where the terminal device 1 functions as a call originating terminal. By contrast, if the terminal device 1 functions as a call receiving terminal, the terminal device 1 stores a desired accounting method in a reply message responding to the call setting message sent by the terminal from which the terminal device 1 receives the call, and sends the reply message to the network NW.

According to the seventh embodiment, it is feasible to provide the accounting methods each exhibiting a higher degree of freedom than by the conventional accounting methods capable of setting the accounting methods only by the pre-registration method and on only the accounting-basis (e.g., on a monthly base).

Note that the configuration for displaying the accounting value of every accounting mode applicable to a given communication service as explained in the first embodiment, is not an indispensable element for the seventh embodiment.

[Eighth Embodiment]

Next, an eighth embodiment of the present invention will be described. The eighth embodiment is what is embodied about a service that enables the subscriber to browse records on the communications and to select the accounting method on the basis of contents of the communication records.

The accounting methods for the communication services at the present are diversified, wherein discount services such as an off-time-zone discount, a local discount, a year-by-year discount etc, are added to the time-basis accounting, the rate accounting and so forth. It is considered that other multiple user-oriented accounting modes will come out from now onwards. The subscriber of the communication service must find out and selects by himself or herself an accounting mode optimal to the subscriber out of the multiplicity of accounting modes. A system for supporting the user to select the optimum accounting mode will hereinafter be described.

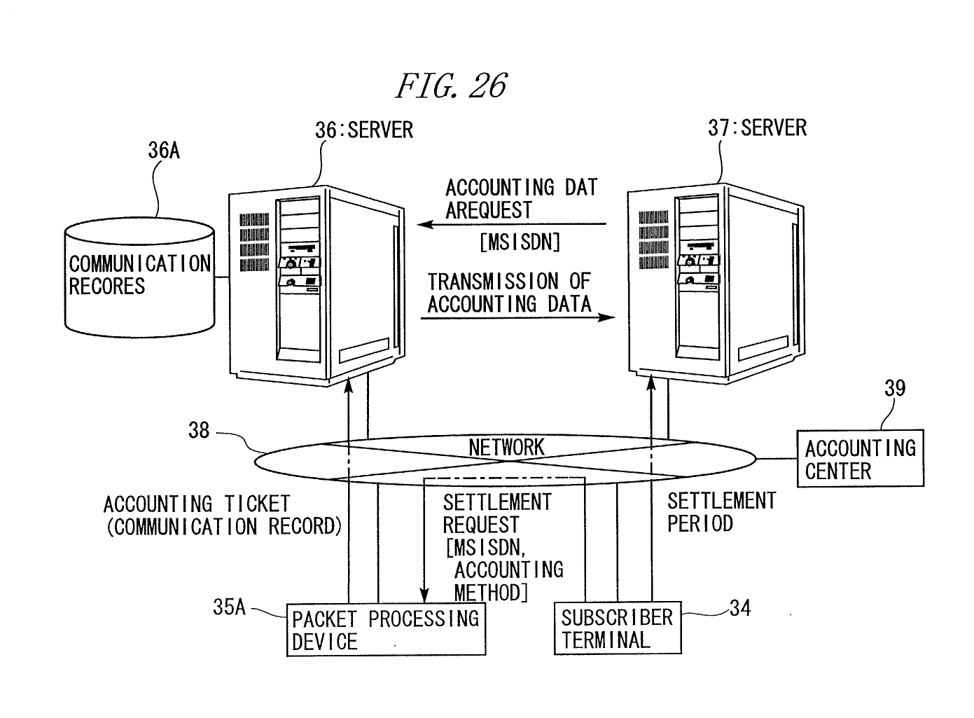

FIG. 26 is a diagram showing a system architecture in the eighth embodiment. Referring to FIG. 26, the system is configured by subscriber terminal devices 34 connected to each other via a network 38, a packet processing device 35A, a server 36 and a server 37.

The terminal device 34 corresponds to the terminal device 1 in the first embodiment and has substantially the same configuration as that shown in FIG. 2. The packet processing device 35A corresponds to the packet processing device 35 in the network NW in the first embodiment. The server 36 functions as an information bank including a database 36A for accumulating the communication records of the subscriber. Further, the server 37 (corresponding to an accounting quantity calculation device) is stored with the accounting methods that can be provided by a communication service provider (a common carrier) and an accounting calculation program (containing the accounting degrees).

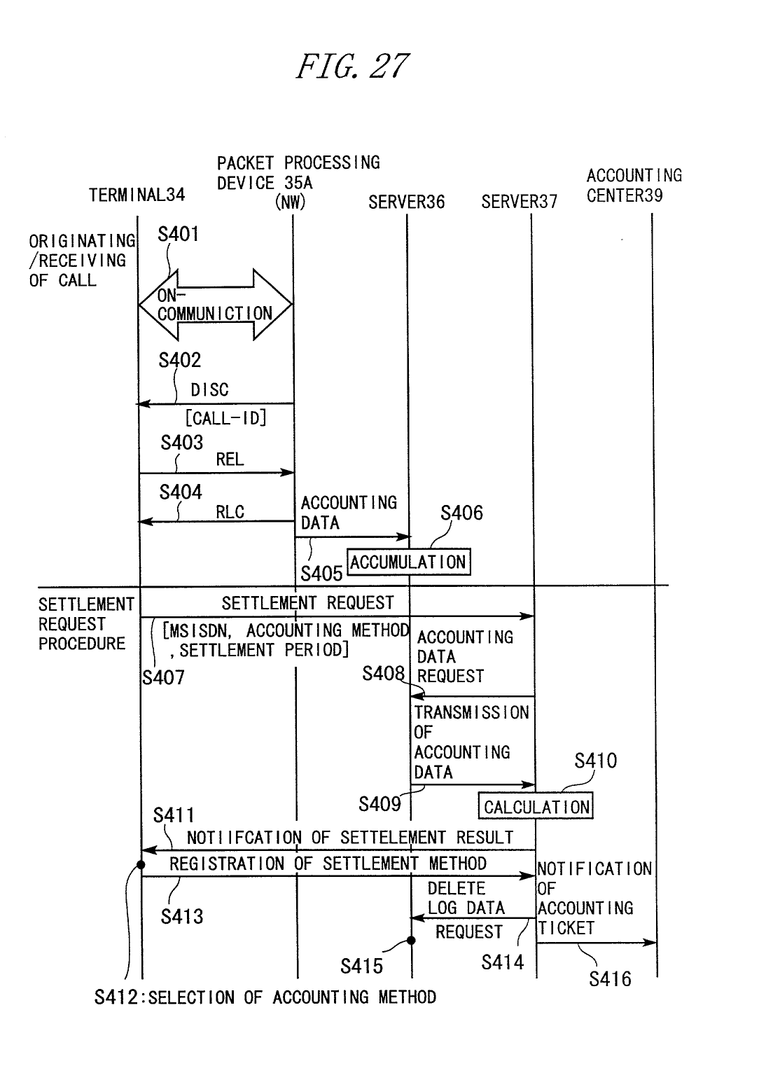

FIG. 27 is a sequence diagram showing an operational example (the accounting method for the communication service) of the system in the eighth embodiment shown in FIG. 26. Referring to FIG. 27, the terminal device 34 establishes a call connection through the packet processing device 35A and performs the communications, and, when the communication come to an end, the call disconnection process is executed between the two terminal devices (step S404˜S404).

The accounting elements (the communication time, the packet quantity, the packet count etc) of the packet communication concerned are counted by the terminal device 34 or the packet processing device 35A, and retained by the packet processing device 35A.

Thereafter, the packet processing device 35A creates accounting data as communication records containing a subscriber's identifier (MSISDN), the counted results, log information (a year/month/date, a communication starting time and a communication ending time), and transmits the accounting data to the server 36 (step S405).

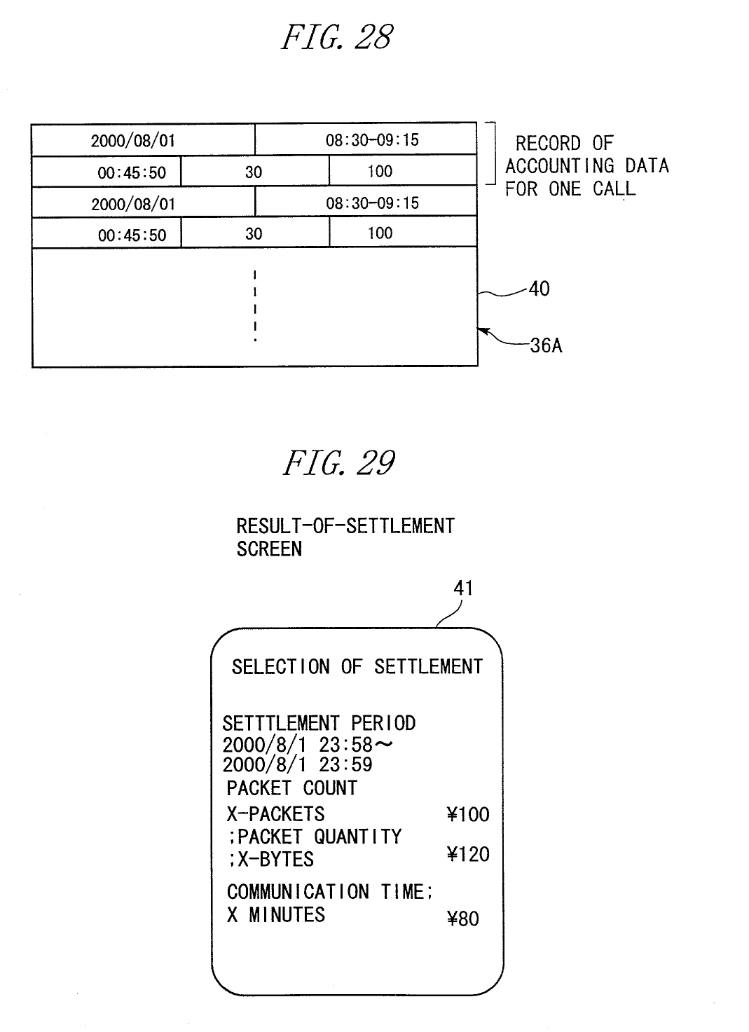

The server 36 accumulates the accounting data (the communication records) received from the packet processing device 35A with respect to every subscriber in the database 36A (step S406). FIG. 28 is a diagram showing an example of the communication records (the accounting data : communication hysteresis) corresponding to a given subscriber identifier stored on the database 36A. FIG. 28 shows a storage area 40 provided for every subscriber identifier on the database 36A. The storage area 40 is stored with a record containing the accounting data for one call (communication).

The record consists of log information for one call and counted results (a communication time, packet count and a packet quantity). The records are sorted based on the log information (according to an ascending or descending order of the log information) and function as a communication hysteresis of a given subscriber.

Accordingly, a desired storage area can be searched with the subscriber identifier serving as a key from the database 36A, and further a desired record can be searched with a year/month/date and a period serving as keys therefrom.

Referring back to FIG. 27, the following settlement request procedure is thereafter carried out as the necessity may arise. Namely, the subscriber, if desiring a settlement of the fee for the communication service, operates the terminal device 34 and inputs an indication of a request for the settlement.

Then, the terminal device 34 connects t the server 37, and transmits the settlement request containing a subscriber identifier, information on at least one accounting method desired for application by the subscriber and information on a settlement period (from X minutes past X O'clock, X-th day of X-month, year of X to X minutes past X O'clock, X-th day of X-month, year of X) (step S407).

The terminal device 34 can connect to the server 37 by the existing connection methods such as specifying a URL (Uniform Resource Locator), dialing of a special number allocated to the server 37, and so on.

The server 37, when receiving the settlement request, creates an accounting data request containing the subscriber identifier and the settlement period that are contained in this settlement request, and transmits the thus created accounting data request to the server 36 (step S408).

The server 36, when receiving the accounting data request, searches within the database 36A in a way that uses, as keys, the subscriber identifier and the settlement period contained in the accounting data request, and obtains a single or plural pieces of accounting data coincident with these keys. Subsequently, the server 36 transmits the accounting data (communication records) obtained to the server 37 (step S409).

The server 37, upon receiving the accounting data, executes an accounting calculation program and thereby calculates an accounting quantity by use of the accounting data received, the accounting method contained in the settlement request and the information on the accounting degree.

Namely, the server 37 obtains the accounting quantity about the accounting data for every accounting method. The information on the accounting degree may be, as described above, registered beforehand in the server 37 and may also be given to the server 37 from the packet processing device 35 according to the necessity.

The server 37, when obtaining the accounting quantity (fee) for every accounting method, creates a message of a result-of-settlement notification containing the settlement period, the accounting data and the accounting quantity. At this time, the server 37 retains the information on the discount services such as a local discount, an off-time-zone discount etc, and may obtain an amount of money of the accounting quantity discounted based on the information on the discount service. Thereafter, the server 37 transmits the created message of the result-of-settlement notification to the terminal device 34 (step S411).

The terminal device 34, when receiving the result-of-settlement notification, displays on the display device a result-of-settlement screen 41 based on the information contained in this result-of-settlement notification. FIG. 29 is a diagram showing a display example of the result-of-settlement screen 41. A settlement period, a total value of the respective counted values of the accounting data within the settlement period and an accounting quantity (amount of money) for this total value, are displayed on the result-of-settlement screen.

The subscriber, when selecting an optimum accounting method with reference to the result-of-settlement screen 41, operates the terminal device 34 to display a settlement method selection screen on the display device. The settlement method selection screen has substantially the same display layout as, for instance, the accounting mode selection screen 12 shown in FIG. 3, and displays the accounting methods applicable to the settlement of the accounting quantity.

The subscriber selects (clicks) any one of the settlement methods by manipulating the cursor K displayed on the selection screen (step S412). Then, the terminal device 34 creates a settlement method registration message (a reply message to the result-of-settlement notification) containing the information on the selected settlement method, and sends this message to the server 37 (step S413).

The server 37, upon receiving the settlement method registration message, records the settlement method contained in the settlement method registration message. Subsequently, the server 37 requests the server 36 to erase the accounting data (records) obtained from the server 36 in response to a settlement request (step S414). The server 36, when receiving the request, erases the records concerned from the database 36A (step S415). This process prevents double-accounting.

Thereafter, the server 37 issues an accounting ticket containing the subscriber identifier, the settlement target communication records (which are the information for specifying the communication service concerned but are not indispensable), the settlement period, the settlement method, the counted value (an integrated value of the counted values corresponding to the respective communication records if there are a plurality of communication records) corresponding to the settlement method, and the information on the accounting degree (which is unnecessary if the accounting center 39 has), and notifies the accounting center 39 of this accounting ticket (step S416).

The accounting center 39 calculates a fee relative to the settlement target communication records on the basis of the information contained in the accounting ticket. Note that the accounting center 39 may receive the fee calculated by the server 37, and the fee calculation by the accounting center 39 itself may be omitted.

According to the eighth embodiment, the subscriber is able to refer to the accounting quantity for every accounting method with respect to the packet communications within the settlement period specified by the subscriber himself or herself. Then, the subscriber can settle the fee (accounting) for the packet communications within the settlement period by the optimum settlement method selected as a result of the reference.

Namely, according to the eighth embodiment, the subscriber is able to select the accounting method as the subscriber intends based on the communication records. Further, the subscriber can register the accounting method after the end of the communication (call). Moreover, the subscriber can register the accounting method immediately after the communication finishes. In addition, the subscriber is able to register an accounting method of a category other than the pre-registration method.

Note that the architecture in the eighth embodiment is that the server 37 calculates the accounting quantity (amount of money), and the result-of-settlement screen 41 indicating the accounting quantity calculated is displayed on the display of the terminal device 34. As a substitute for this, the following architecture may also be adopted.

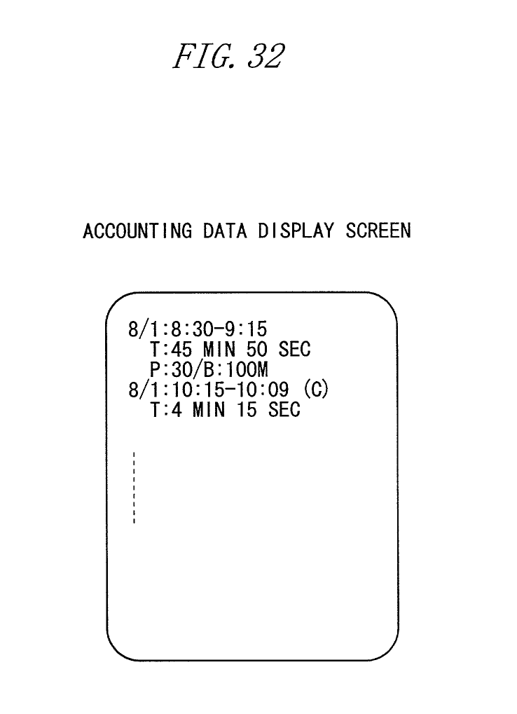

To be specific, the subscriber of the terminal device 34 accesses the database 36A of the server 36 by operating the terminal device 34 as the necessity may arise, obtains necessary items of accounting data from the database 36A and displays the accounting data on the display device (see FIG. 32). Then, the subscriber selects the accounting method that should be applied to the settlement with reference to the accounting data displayed. The terminal device 34 notifies the server 37 the selected accounting method, and the server 37 registers the notified accounting method.

In the case of adopting the architecture described above, it is not required that the accounting method be contained in the message of the settlement request. The server 37 executes, based on the accounting method receiving from the terminal device 34 and registered beforehand, the process in step S410 and further executes steps S414 and S416. On the other hand, the terminal device 34 is required to neither select the settlement method (the accounting method) on the result-of-settlement screen 41 nor transmit the settlement method registration message.

[Ninth Embodiment]

Next, a ninth embodiment of the present invention will be explained. The ninth embodiment has substantially the same system architecture as the eighth embodiment (see FIG. 26). The ninth embodiment is, however, different in terms of operation from the eight embodiment.

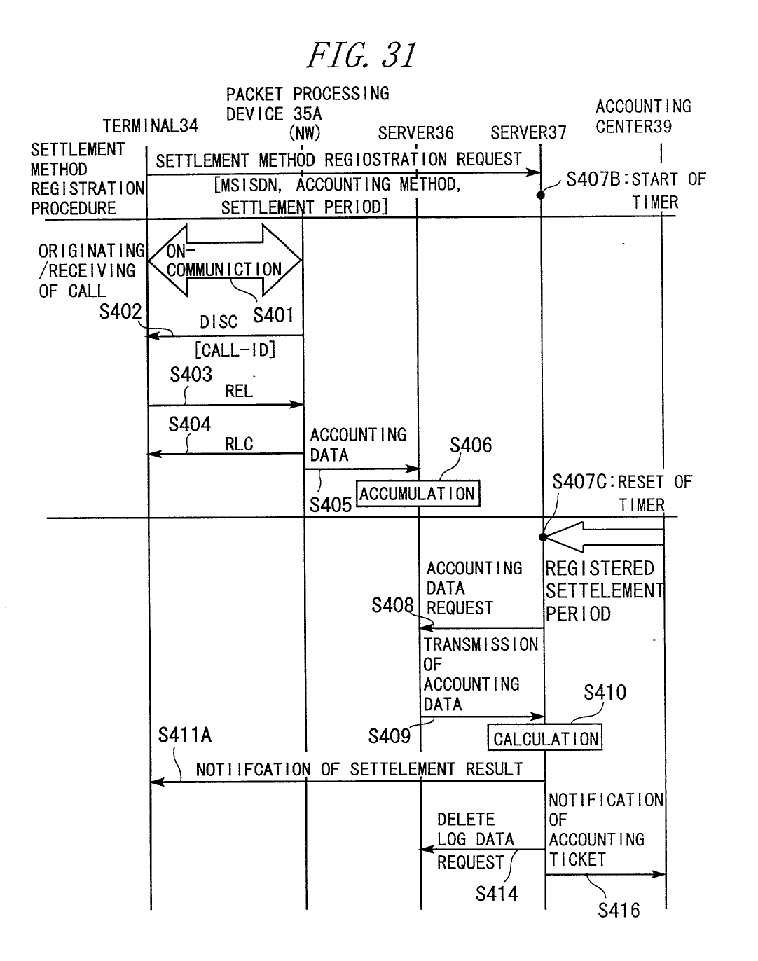

FIG. 31 is a sequence diagram showing an operational example (the accounting method for the communication service) of the system in the ninth embodiment. Hereinafter, the discussion will be focused on different points while the explanations of the components common to the eighth embodiment and marked with the same numerals are omitted.

Referring to FIG. 31, the user (subscriber) of the terminal device 34 registers previously the settlement method (the accounting method applied to the settlement of the communication fee) before performing the communications (step S407A). that is, the subscriber invokes the settlement method selection screen (not shown) on the display device by manipulating the operation key 30, and inputs the settlement period and the accounting method adopted as a settlement method on this selection screen.

Then, the terminal device 34 creates a settlement method registration request message containing the subscriber identifier (MSISDN), the accounting method and the settlement period, and sends this message to the server 37. The server 37, when receiving the settlement method registration request message, registers on an unillustrated recording medium, the settlement period, the accounting method and the subscriber identifier contained on the above message.

Thereafter, the server 37 sets an unillustrated timer to count the settlement period, and the timer starts counting the settlement period (step S407B). When the counted time reaches the settlement period, the timer is rest (step S407C). thereafter, the timer resumes counting the settlement period. Thus, the timer is constructed to be reset at an interval of the settlement period.

When the timer is reset, the server 37 executes substantially the same processes as steps S408˜S410. Namely, the server 37 obtains the accounting data accumulated in the database 36A from the server 36 by use of the subscriber identifier and the settlement period registered. The settlement period starts at a starting time of the timer and ends at a reset time of the timer. Then, the server 37 calculates the accounting quantity (amount of money) corresponding to the accounting method for the packet communication within the settlement period concerned (step S410).

Then, the server 37 creases a result-of-settlement notification message containing the settlement period, the settlement method, the counted value of the accounting element corresponding to the settlement method, and the accounting quantity (amount of money), and transmits this message to the terminal device 34 (step S411A). The terminal device 34, when receiving the result-of-settlement notification message, displays the information contained in the above message on the screen of the display device. The subscriber is thereby able to grasp that the packet communications performed within the settlement period are charged a fee based on the settlement method (the accounting method) selected by the subscriber himself or herself, and also grasp the accounting quantity thereof.

On the other hand, the server 37, as in the eighth embodiment, requests the server 36 to erase the accounting data with the settlement done (step S414), and the accounting data concerned are erased from the database 36A (step S415). Further, server 37 notifies the accounting center 39 of the same accounting ticket as that in the eighth embodiment (step S416).

According to the ninth embodiment, the settlement period and the settlement method are registered beforehand in the server 37, whereby the fee for the packet communication can be settled for every settlement period. Therefore, though a length of the settlement period cannot be changed, as in the eighth embodiment, the settlement request may not be sent each time to the server 37.

Note that the following architecture may be adopted as a substitute for those in the eighth and ninth embodiments. Specifically, when each of the records accumulated in the database 36A is once read in response to the accounting data request, a flag indicating the settlement done is set in the readout record (ON state). Thereafter, this record is treated invalid. In this case, the process that the server 37 transmits the accounting data erasing request to the server 36, may not be executed (step S414).

Further, the following architecture may also be taken as a substitute for those in the eighth and ninth embodiments. To be specific, in step S407A, the terminal device 34 registers in the server 37 a plurality of accounting methods applicable to the communication service (the packet communications), a condition (an accounting method selection condition: this may be, e.g., the accounting method by which the accounting quantity is minimized) for selecting a specified accounting method among the plurality of accounting methods, and a settlement period.

The server 37, each time the settlement period elapses, obtains accounting quantities corresponding to the plurality of accounting methods registered, then selects the accounting method by which the obtained accounting quantity meets the accounting method selection condition from the plurality of accounting methods registered, and registers it as the accounting method applied to the settlement on the unillustrated recording medium. With this contrivance, the accounting method satisfying the accounting method selection condition is automatically selected for every settlement period and applied to the settlement.

The processes described above can be actualized by adding, to an accounting calculation program executed by the server 37, a step of specifying the accounting method that meets the accounting method selection condition, and a step of registering the specified accounting method as an accounting method applied to the settlement.

[Tenth Embodiment]

Next, a tenth embodiment of the present invention will be described. The tenth embodiment has the common points to the eighth and ninth embodiments, and therefore the discussion will be focused on different points while the explanations of the common components marked with the same numerals are omitted.

The tenth embodiment is that the accounting data are accumulated on the side of the terminal device, and an accounting quantity for the communication service (the packet communication) with a predetermined period is calculated on the side of the terminal device.

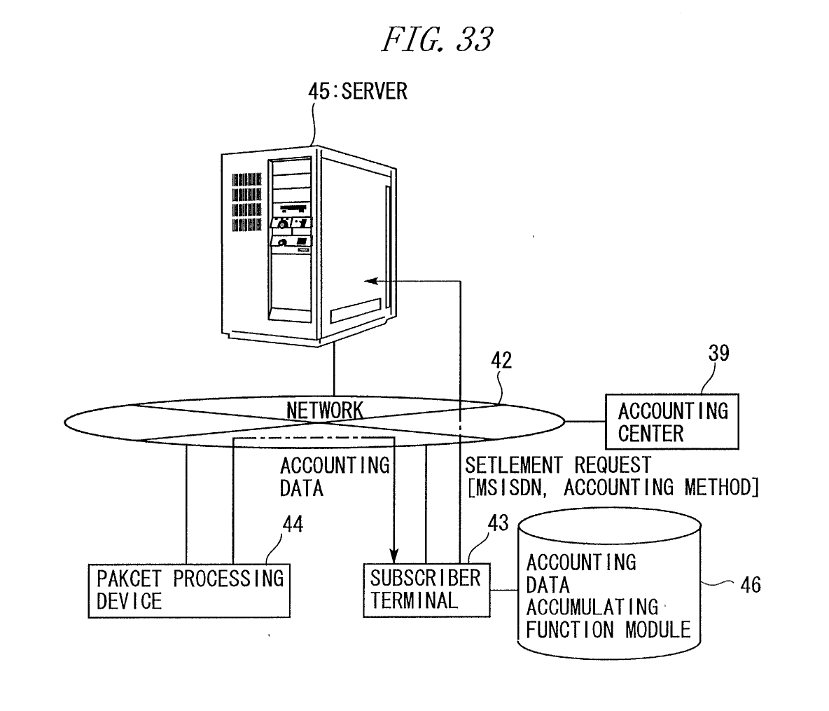

FIG. 33 is a diagram showing a system architecture in the tenth embodiment. Referring to FIG. 33, the system is configured by a network 42, a subscriber terminal device 43 connected to the network 42, a packet processing device 44, a server 45 (corresponding to a settlement program providing device), and the accounting center 39.

The terminal device 43 corresponds to the terminal device 34 (see FIG. 26) and has substantially the same architecture as that of the terminal device 1 (see FIG. 2). The terminal device 43 is connected to an accounting data accumulating function module 46 subordinate (connected only) to the terminal device 43.

The accounting data accumulating function module 46 corresponds to the database 36A in the eighth embodiment, and is stored with the accounting data for the communication service (the packet communication) which have been used by the terminal device 34.

Namely, the accounting data accumulating function module 46 retains the records of the accounting data (communication records) stored in the storage area 40 shown in FIG. 28. Note that the accounting data accumulating function module 46 is structured by use of a recording medium such as a hard disk etc mounted in or connected to the terminal device 43, or by use of other terminal device mounted with the recording medium including the database. The packet processing device 44 corresponds to the packet processing device 35A shown in FIG. 26.

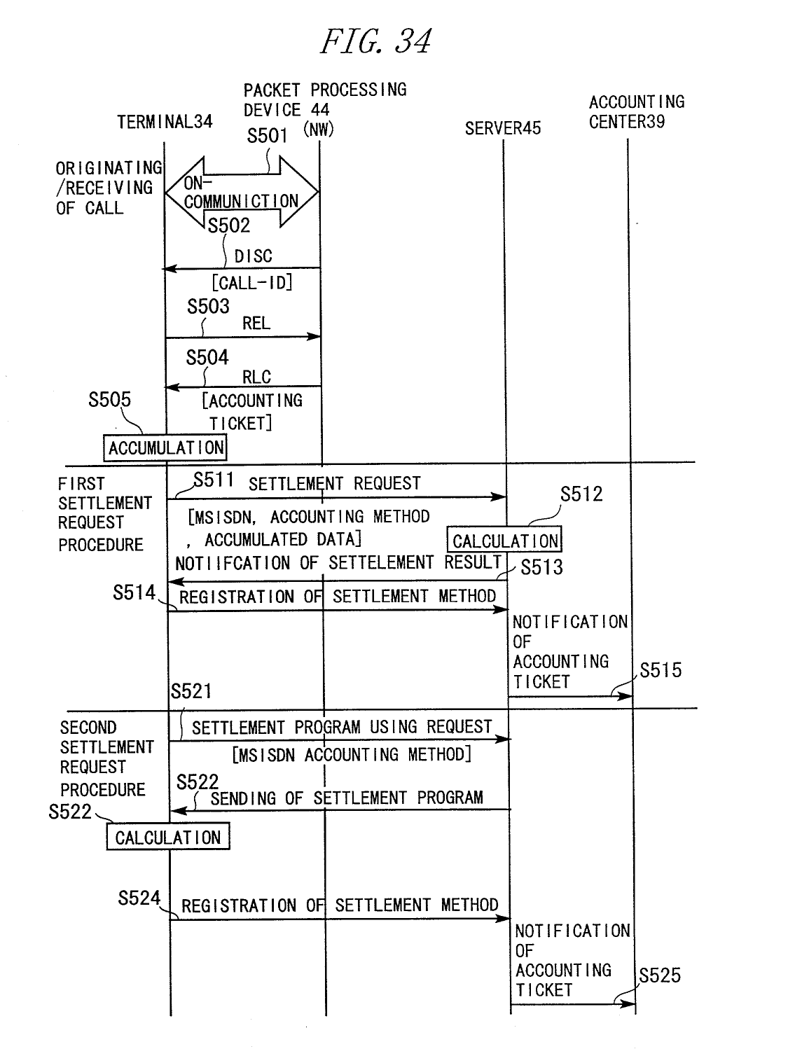

FIG. 34 is a sequence diagram showing an operational example in the tenth embodiment. Referring to FIG. 34, the terminal device 43 performs the packet communications via the packet processing device 44 (step S501). When the packet communications come to an end, a call disconnecting process between the terminal device 43 and the packet processing device 44 is executed (step S502, S503).

The packet processing device 44 counts quantities or numeric values (a packet quantity, a packet count and a communication time) serving as accounting elements for the accounting method during the packet communication. In the call disconnecting process, the packet processing device 44 creates a RELEASE COMPLETE message including accounting ticket information containing the counted values of the accounting elements, log information (a communication year/month/date, a communication starting time and a communication ending time) and sends this message to the terminal device 43 (step S504).

The terminal device 43, when receiving the accounting ticket information from the packet processing device 44, stores the accounting data accumulating function module 46 with the accounting ticket information (the values of the accounting elements and the log information) (step S505) Note that the terminal device 43 may obtain the log information and count the numeric values or quantities of the accounting elements during the packet communication (in the process of utilizing the communication service), and may store these values in the accounting data accumulating function module 46.

Thereafter, the terminal device 43 executes a settlement request procedure with the server 45 according to the necessity. FIG. 34 shows a first settlement request procedure and a second settlement request procedure into which the settlement request procedure is divided.

To start with, the first settlement request procedure will be explained. the subscriber, if desiring for the settlement of a given item of accounting data or a single or plural items of accounting data within a predetermined period, operates the terminal device 43 to display details of the accounting data accumulated in the accounting data accumulating function module 46 on the display device (not shown). For instance, as shown in FIG. 32, the details of the accounting data are displayed on the display device. The subscriber refers to the details of the accounting data displayed, and specifies one or more items of accounting data of which the settlement desired by the subscriber. Further, the subscriber specifies a desired accounting method with respect to the specified accounting data.

Then, the control unit 2 of the terminal device 43 reads the specified accounting data from the accounting data accumulating function module 46. The control unit 2 creates a settlement request message containing the readout accounting data, the subscriber identifier (MSISDN) and the information on the specified accounting method, and transmits this message to the server 45 (step S511).

The server 45, when receiving the settlement request message, executes substantially the same processes as step S410 (see FIG. 31) explained in the eighth embodiment and step S411A (see FIG. 31) explained in the ninth embodiment, and transmits substantially the same result-of-settlement notification as that in the ninth embodiment to the terminal device 43 (steps S512, S513).

The terminal device 43, when receiving the result-of-settlement notification, displays the information contained in this message on the screen of the display device. The subscriber is thereby able to comprehend the accounting quantity with respect to one or more items of accounting data specified by the subscriber himself or herself for every self-specified accounting method.

Thereafter, substantially the same processes as steps S412, S413 (see FIG. 27) explained in the eighth embodiment, are executed, and the terminal device 43 transmits a settlement method registration message to the server 45 (step S513).

The settlement method registration message contains the information on the accounting method selected as the settlement method by the subscriber, and the information (corresponding to the settlement period in the eighth embodiment) for specifying the settlement target accounting data. The information indicating the settlement period, as in the eighth embodiment, may be applied as a piece of accounting data specifying information.

The server 45, upon receiving the settlement method registration message, carries out substantially the same process as step S416 in the eighth embodiment, and sends the accounting ticket to the accounting center 39 (step S515).

Next, the second settlement request procedure will be described. The subscriber, if desiring for the settlement of a given item of accounting data or a single or plural items of accounting data within a predetermined period, specifies and inputs one or more accounting methods that should be applied to the settlement by operating the terminal device 43, and thereafter inputs a request for downloading the settlement program.

Then, the terminal device 43 (precisely, the control unit 2) creates a usage request message for using the settlement program containing the subscriber identifier (MSISDN) and the information on the specified accounting method, and transmits this message to the server 45 (step S521).

The server 45 is previously set to provide the settlement program in response to the request given from the terminal device 43, and, when receiving the usage request message for using the settlement program, downloads (sends) the settlement program corresponding to the accounting method contained in this message into the terminal device 43 (step S522).

In the terminal device 43, when receiving the settlement program (when downloaded with the same program from the server 45), the control unit executes the settlement program, thereby calculating the accounting quantity per specified accounting method (step S523).

On the occasion of executing the settlement program, the subscriber operates the terminal device to display on the display device the accounting data accumulated on the accounting data accumulating function module 46 by the same procedure as the first settlement request procedure. Then, the subscriber refers to the accounting data and specifies one or more items of settlement target accounting data.

When the settlement program is executed, one or more items of accounting data specified are read from the accounting data accumulating function module 46, and the accounting quantity (an amount of money) with respect to the readout accounting data is calculated for every accounting method (step S523).

The terminal device 43, upon finishing the execution of the settlement program, as in the eighth embodiment, displays the result-of-settlement screen 41 on the display device. The subscriber refers to the result-of-settlement screen 41, and selects and inputs the optimum accounting method as a settlement method from the specified accounting methods. Then, the terminal device 43 creates the settlement method registration message containing the information on the optimum accounting method (settlement method) inputted, and transmits this message to the server 45 (step 524). Thereafter, substantially the same process as step S515 in the first settlement request procedure is executed (step S525). Note that the settlement program downloaded into the terminal device 43 may be deleted after being executed and again downloaded each time the settlement is implemented.

According to the tenth embodiment, the accounting data are accumulated on the side of the terminal device, and hence the subscriber refers to the accounting data as the necessity may arise and can determine whether the settlement is implemented or not. Further, the settlement can be done by the desired accounting method per packet communication. Accordingly, as in the eighth and ninth embodiments, the settlement of the accounting data within the predetermined period can be also conducted by applying the desired accounting method.

[Eleventh Embodiment]

Next, an eleventh embodiment of the present invention will hereinafter be described. The eleventh embodiment will deal with a system for providing a connections service for performing the communication (call) by selecting an optimum communication method and based on this selected communication method, which involves inputting, when starting the communication, contents (a category of service, a predicted communication quantity etc) of the communication, and a communication method determining parameter (for determining a communication method exhibiting a minimum fee and minimum communication time).

The system in the eleventh embodiment includes, as in the first embodiment, a terminal device 48 and a network NW1 for providing a variety of communication services to the terminal device 48. The terminal device 48 has substantially the same architecture of the blocks (functions) as that of the terminal device 1 explained in the first embodiment (see FIG. 2). The network NW1 provides the terminal device 48 with the communication services as in the first embodiment.

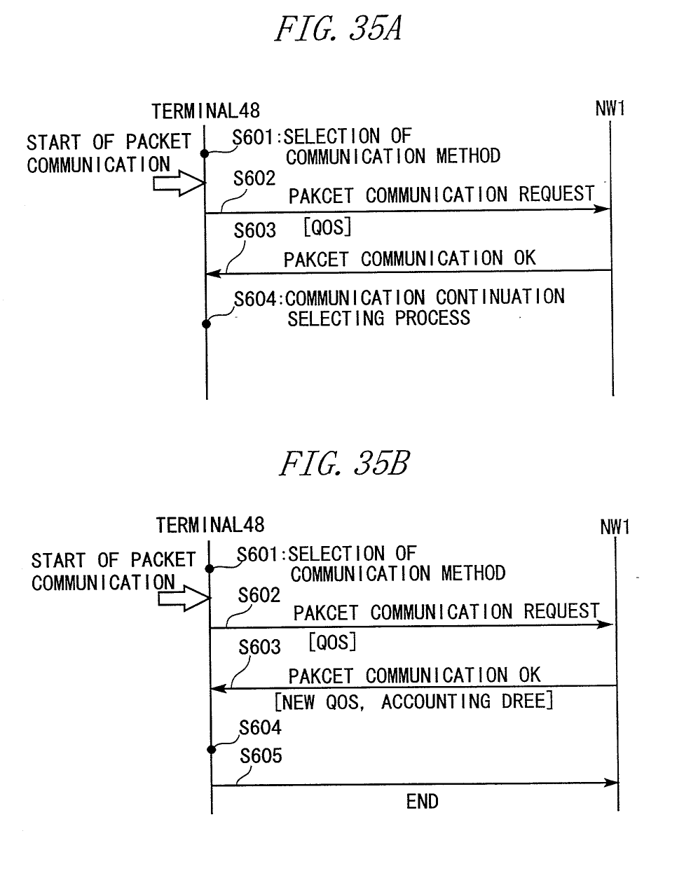

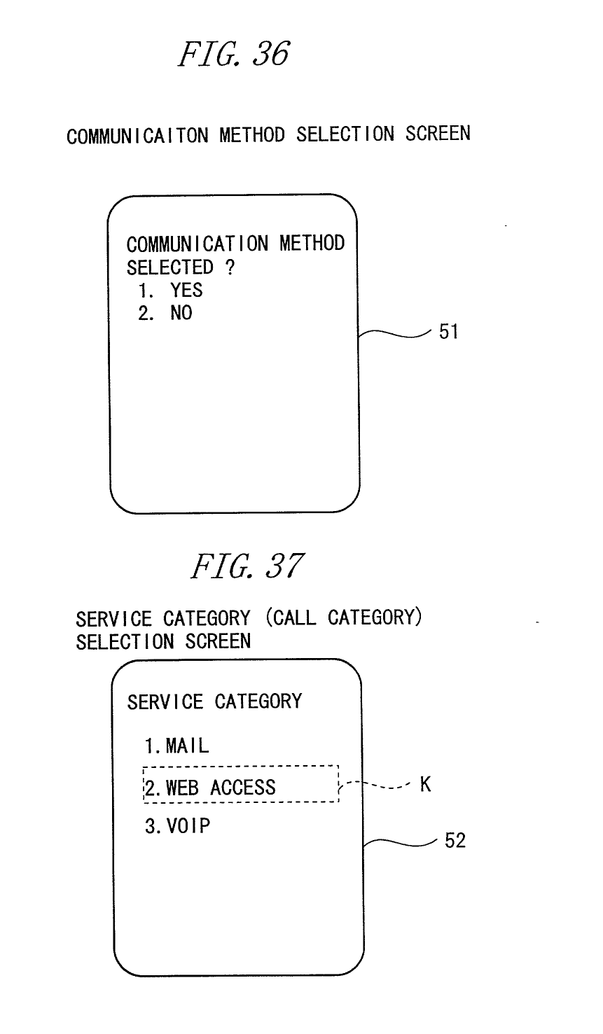

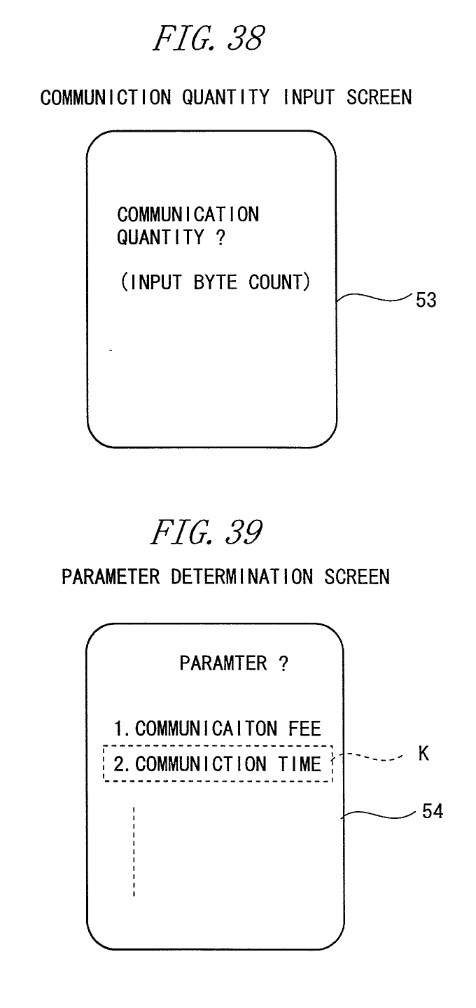

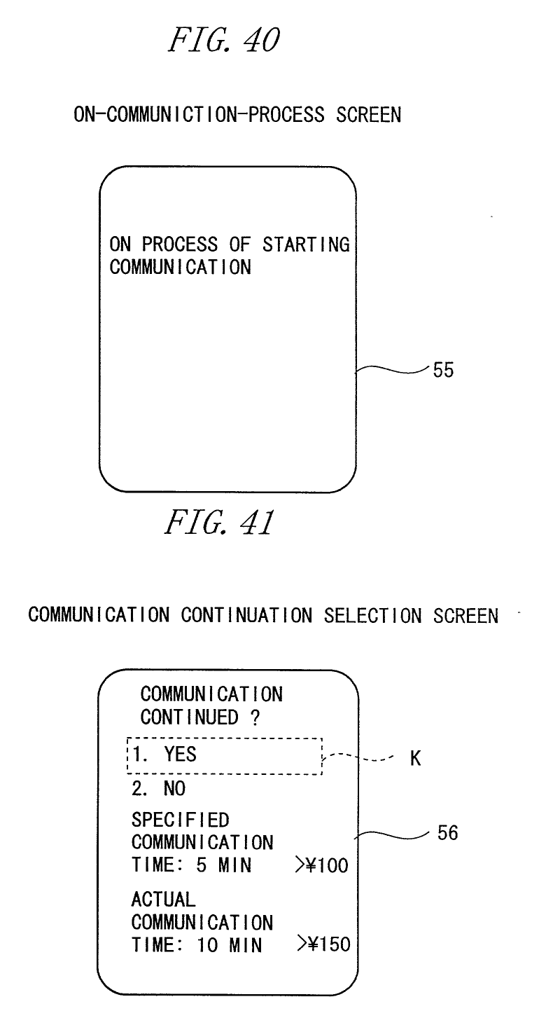

FIGS. 35(A) and 35(B) are sequence diagrams each showing an operational example (a method of setting a quantity of the communication service) in the system according to the eleventh embodiment. FIG. 36 is a diagram showing a display example of a selection screen 51 for selecting the communication method. FIG. 37 is a diagram showing a display example of a selection screen 52 for selecting a service category (call category). FIG. 38 is a diagram showing a display example of an input screen 53 for inputting a communication quantity. FIG. 39 is a diagram showing a display example of a parameter determination screen 54. FIG. 40 is a diagram showing a display example of an on-communication-process screen 55. FIG. 41 is a diagram showing a display example of a communication continuation selecting screen 56.

A case where the terminal device 48 performs the packet communications via the network NW1, will be exemplified. Referring to FIG. 35(A), the user (a subscriber of the packet communication service) of the terminal device 48, when starting the packet communication, executes a communication method selecting process by operating the terminal device 48 (step S601).

The communication method selecting process (step S601) is executed by the following manner. At first, the subscriber operates the terminal device 48 and inputs an indication of displaying the communication method selection screen 51 (see FIG. 41. Then, the control unit 2 and the display unit 5 (see FIG. 1) of the terminal device 48 display the selection screen 51 on the display device (LCD 9) of the terminal device 48.

A question of whether the communication method is selected and answer options [1. Yes] and [2. No] are displayed on the selection screen 51. The subscriber answers [1. Yes] if selecting the communication method, and answers [2. No] if not.

Herein, if the subscriber answers [2. No], the same process of starting the packet communication as the conventional process, is executed, whereby the packet communication is performed. Whereas if the subscriber answers [1. Yes], the control unit 2 and the display unit 5 display the service category selection screen 52 (see FIG. 37) on the display device.

A plurality of service categories selectable when performing the packet communication are displayed on the selection screen 52. In an example shown in FIG. 37, [1. E-mail] [Web access (WWW)] and [VoIP] are displayed as the service categories. The subscriber selects any one of the service categories by manipulating the cursor K displayed on the selection screen 52. The selected service category is recorded on the memory module 4.

Subsequently, the control unit 2 and the display unit 5 display the communication quantity input screen 53 (see FIG. 38) on the display device. An indication for prompting the subscriber to input a predicted communication quantity (byte count) in the packet communication of this time. The subscriber displays the communication quantity by use of the operation key 10.

Note that the subscriber, as discussed in the eighth through tenth embodiments, operates the terminal device 48 and refers to the communication records accumulated on the side of the terminal device or the network, and is thereby able to predict the communication quantity.

When the subscriber inputs the communication quantity, the control unit 2 records the inputted communication quantity on the memory module 4. Next, the control unit 2 and the display unit 5 display the parameter determining screen 54 (see FIG. 39) on the display device.

The parameter determining screen 54 is a screen used for the subscriber to specify a communication parameter (a communication quality condition) conceived most important in the packet communication performed this time. In an example shown in FIG. 39, [1. Communication fee] and [2. Communication time] are displayed as a plurality of communication parameters that can be specified on the screen 54.

The subscriber specifies any one of the communication parameters by manipulating the cursor K displayed on the screen 54. For instance, if desiring to perform the packet communication with a minimum fee this time, the subscriber specifies [1. Communication fee] . By contrast, if desiring to perform the packet communication in a minimum time this time, the subscriber specifies [2. Communication time] . Then, the on-communication-process screen 55 (see FIG. 40) is displayed on the display device.

When the parameter is specified, the control unit 2 of the terminal device 48, creates a packet communication request message. At this time, the control unit 2 sets the service category and the communication quantity recorded on the memory module 4, and a QoS parameter based on the specified parameter, in the QoS field (see FIG. 5). For example, if the subscriber specifies [2. Communication time], the control unit 2 sets a QoS parameter exhibiting a minimum communication time in the QoS field. The terminal device 48 sends the packet communication request message created to the network NW1 (step S602).

The network NW1, when receiving the packet communication request message, executes a call setting process with the contents set in the QoS field of this message. At this time, if unable to set the call with the contents set in the QoS field, a negotiation is conducted, and the call is set again with a call-settable QoS.

Thereafter, the network NW1, when finishing the call setting process on the side of the network NW1, creates a packet communication “OK” message (a reply message) in which the QoS filed contains the QoS actually set for the packet communication of this time, and transmits this message to the terminal device 48 (step S603). When the terminal device 48 receives the reply message, the call is established, and there comes to an on-packet-communication status.

When the terminal device 48 receives the reply message, the following communication continuation selecting process is executed. Namely, the control unit 2 of the terminal device 48 calculates a communication fee or a communication time in the case of performing the packet communication with the QoS set in the QoS field of the packet communication request message. Subsequently, the control unit 2 calculates a communication fee or a communication time in the case of performing the packet communication with the QoS set in the QoS field of the reply message. Then, the control unit 2 and the display unit 5 display, on the display device, the communication continuation selection screen 56 (see FIG. 41) for displaying the results of the respective calculations and inquiring the subscriber about a continuation of the communication.

Displayed on the communication continuation selection screen 56 are a question of whether the communication continues, answer options, a (specified) communication time or a (specified) communication fee as a communication condition in the case of performing the communication with the QoS corresponding to the communication parameter specified, and an (actual) communication time or an (actual) communication fee as a communication condition in the case of performing the communication with the QoS actually set by the call setting process. The screen in the example shown in FIG. 41 displays that the specified QoS can not be attained, and the actual communication time becomes longer than the specified communication time.

The subscriber refers to the screen 56 and selects whether or not the communication continues, by manipulating the cursor K displayed on the screen 56. If the subscriber selects the continuation of the communication ([1. Yes]), the established packet communication continues.

By contrast, if the subscriber does not select the continuation of the communication ([2. No]), the terminal device sends a packet communication end message (DISC message) to the network NW1 (FIG. 35(B); step S605), and the call disconnection process is carried out.

According to the eleventh embodiment, when the user (the subscriber of the packet communication service) of the terminal device 48 specifies the service category, the communication quantity and the communication parameter (the communication quality condition) by operating the terminal device 48, the packet communication request message (the call setting message) in which the QoS satisfying the communication condition, is created, and the call setting process for actualizing the QoS set is executed based on the call setting message.

With this process, the subscribe can perform the packet communication (to be provided with the communication service) with the communication parameter (the communication quality condition) desired by the subscriber himself or herself without setting the QoS parameter in the complicated manner).

On the other hand, when the call is established, the specified communication quality (the specified communication time or the specified communication fee) and the communication quality (the actual communication time or the actual communication fee) set actually, are displayed on the display device of the terminal device 48. The subscriber is thereby able to comprehend whether or not the specified communication quality condition is met. If the communication quality condition is not met, the subscriber selects the non-continuation of the communication, thereby making it possible to end the packet communication concerned. Accordingly, only when the desired communication quality condition is satisfied, the subscriber can perform the packet communication.

Note that the communication quality condition may be set per service category in the eleventh embodiment. Therefore, the selection of the service category is not an indispensable requirement for configuring the present invention.

What is claimed is:

1. A method of displaying an accounting state for a communication service by a terminal device, comprising steps of:
receiving a communication service, to which a plurality of accounting methods can be applied, from a network and providing the communication service for a subscriber; and
displaying accounting quantities corresponding to each of said plurality of accounting methods in the process of utilizing the communication service.

2. A method of displaying an accounting state for a communication service by a terminal device according to claim 1, further comprising steps of:
obtaining a piece of information on an accounting degree corresponding to each of said plurality of accounting methods from said network when the communication service starts being utilized; and
measuring, in the process of utilizing the communication service, an quantity of an accounting element corresponding to each of said accounting methods, calculating and displaying said accounting quantities corresponding to each of said accounting methods on the basis of the measured result and the accounting degree information.

3. A method of displaying an accounting state for a communication service by a terminal device according to claim 1, further comprising a step of displaying a specified accounting quantity by a display mode that the specified accounting quantity can be distinguished from other accounting quantities.

4. A method of displaying an accounting state for a communication service by a terminal device according to claim 1, further comprising a step of displaying sums corresponding to each of said accounting methods together with said accounting quantities.

5. A method of displaying an accounting state for a communication service by a terminal device according to claim 2, further comprising a step of outputting an alarm, when the quantity of the accounting element corresponding to at least one accounting method reaches a predetermined threshold value.

6. A method of displaying an accounting state for a communication service by a terminal device according to claim 1, further comprising a step of outputting an alarm, when at least one accounting quantity reaches a predetermined threshold value.

7. A method of displaying an accounting state for a communication service by a terminal device according to claim 1, further comprising a step of notifying said network of pieces of information on a specified accounting method selected by the subscriber from said plurality of accounting methods after finishing the communication service so that said specified accounting method is applied to the use of the communication service.

8. An accounting system for a communication service, comprising:
providing means for providing a communication service, to which a plurality of accounting methods can be applied, with a terminal device of a subscriber, through a network; and
recording means for receiving, from the terminal device, information indicating an accounting method selected by the subscriber, and recording the information on a database in order to issue an accounting ticket according to the selected accounting method.

9. An accounting system for a communication service according to claim 8, wherein said providing means provides the subscriber with communication services of a plurality of categories; and
said recoding means receives, from the terminal device, at least one information indicating at least one accounting method corresponding to at least one category selected by the subscriber, and records the information on the database in order to issue an accounting ticket according to the selected accounting method corresponding to the category of the communication service utilized by the subscriber.

10. An accounting system for a communication service, comprising:
means for providing a communication service, to which a plurality of accounting methods can be applied, with a terminal device of a subscriber, through a network; and
means for receiving, when the subscriber utilizes the communication service, at least one information indicates an accounting method, selected by the subscriber, that is applied to the communication service this time, from the terminal device in order to issue an accounting ticket according to the selected accounting method regarding the use of the communication service this time.

11. An accounting system for a communication service, comprising:
means for providing a communication service, to which a plurality of accounting methods can be applied, with a terminal device of a subscriber, through a network;
a database for storing communication records of the communication service whenever the subscriber utilizes the communication service;
means for receiving, from the terminal device, at least one information indicating at least one accounting method selected from the plurality of accounting methods and a specific information indicating at least one communication record as a settlement target;
means for acquiring the settlement target corresponding to the specific information from said database;
means for calculating at least one accounting quantity corresponding to the acquired settling target regarding at least one accounting method which is indicated by the recorded accounting method information;
means for giving the calculated accounting quantity/quantities to the terminal device, the terminal device informing the subscriber of the accounting quantity/quantities from the giving means; and
means for receiving, from the terminal device, an information indicating an accounting method is applied to the settlement target selected by the subscriber, in order to issue an accounting ticket regarding the settlement target.

12. An accounting system for a communication service, comprising:
means for providing a communication service to which a plurality of accounting methods can be applied with a terminal device of a subscriber, through a network;
a database for storing communication records of the communication service whenever the subscriber utilizes the communication service;
means for recoding a settling method information obtained from the terminal device, the settling method information including any of the accounting methods and a settling period information selected by the subscriber;
means for acquiring, whenever the settling period progresses, based on the settling period information, at least one communication record during the settling period as a settling target from the database;
means for calculating an accounting quantity corresponding to the acquired settling target based on the accounting method information; and
means for giving the calculated accounting quantity to the terminal device.

13. An accounting system for a communication service, comprising:
means for providing a communication service to which a plurality of accounting methods can be applied with a terminal device of a subscriber, through a network;
a database for storing communication records of the communication service whenever the subscriber utilizes the communication service, the database is used in order to acquire at least one communication record as a settling target selected by the subscriber;
means for receiving, from the terminal device, the settling target acquired from the database and information indicating at least one accounting method that should be applied to the settling target;
means for calculating at least one accounting quantity corresponding to the settling target on the basis of at least one accounting method indicated by the information from the terminal device; and
means for giving said at least one accounting quantity to the terminal device, the terminal device displaying the given accounting quantity in order to make the subscriber select an accounting method applied to the settling target.

14. An accounting system for a communication service, comprising:
means for providing a communication service to which a plurality of accounting methods can be applied with a terminal device of a subscriber, through a network;
a database for storing communication records of the communication service whenever the subscriber utilizes the communication service; and
means for providing at least one settling program with the terminal device, the terminal device acquiring at least one communication record as a settling target from the database, calculating at least one accounting quantity with regard to at least one accounting method selected from the plurality of accounting methods by operating the settling program, and displaying at least one accounting quantity calculated.

15. A terminal device operated by a subscriber when utilizing a communication service in a network, comprising:
means for transmitting to said network a call setting message in which a quality of service (QoS) corresponding to a communication condition selected by the subscriber is set; and
means for displaying, after receiving a QoS of a call actually connected based on the QoS set in the call setting message, information indicating a communication condition based on the QoS corresponding to the above communication condition, and information indicating a communication condition based on the QoS received from said network.

16. A terminal device comprising:
means for acquiring from the network a communication service to which a plurality of accounting methods can be applied, and providing the communication service with a subscriber; and
means for displaying an accounting quantity corresponding to each of said plurality of accounting methods in the process of utilizing the communication service.

17. A terminal device according to claim 16, further comprising:
means for obtaining a piece of information on an accounting degree corresponding to each of said plurality of accounting methods from said network when the communication service starts being utilized; and
means for measuring, in the process of utilizing the communication service, an quantity of an accounting element corresponding to each of aid accounting methods, calculating and displaying said accounting quantities corresponding to each of said accounting methods on the basis of the measured result and the accounting degree information.

18. A terminal device according to claim 16, further comprising: means for displaying a specified accounting quantity by a display mode that the specified accounting quantity can be distinguished from other accounting quantities.

19. A terminal device according to claim 16, further comprising: means for displaying sums corresponding to each of said accounting methods together with said accounting quantities.

20. A terminal device according to claim 17, further comprising: means for outputting an alarm, when the quantity of the accounting element corresponding to at least one accounting method reaches a predetermined threshold value.

21. A terminal device according to claim 17, further comprising: means for outputting an alarm, when at least one accounting quantity reaches a predetermined threshold value.

22. A terminal device according to claim 16, further comprising: means for notifying said network of pieces of information on a specified accounting method selected by the subscriber from said plurality of accounting methods after finishing the communication service so that said specified accounting method is applied to the use of the communication service.

23. A terminal device comprising:
means for acquiring from a network a communication service to which a plurality of accounting methods can be applied, and providing the communication service with a subscriber;
means for recording communication records on a database whenever the subscriber utilizes the communication service;
means for obtaining at least one communication target as a settling target selected by the subscriber; and
means for transmitting a settlement request including the settling target obtained from the database and at least one accounting method that should be applied to the settling target, the subscriber selecting at least one accounting method from the plurality of accounting methods.

24. A terminal device comprising:
means for acquiring from a network a communication service to which a plurality of accounting methods can be applied, and providing the communication service with a subscriber;
means for recording communication records on a database whenever the subscriber utilizes the communication service;
means for receiving from the network at least one settling program corresponding to at least one accounting method selected from the plurality of accounting methods by the subscriber;
means for acquiring, from the database, at least one communication record as a settling target selected by the subscriber;
means for calculating, by operating the settling program, an accounting quantity corresponding to the settling target with regard to at least one accounting method selected by the subscriber; and
means for displaying at least one accounting method calculated.
